(19) United States
(12) Patent Application Publication
(10) Pub. No.: US 2022/0264883 A1
(43) Pub. Date: Aug. 25, 2022

(54) IMIDAZOTHIAZOLE COMPOUNDS AND METHODS FOR TREATING PLANT NEMATODE INFECTIONS

(71) Applicant: The Governing Council of the University of Toronto, Toronto (CA)

(72) Inventors: Andrew Burns, Toronto (CA); Peter Roy, Toronto (CA)

(21) Appl. No.: 17/624,629

(22) PCT Filed: Jul. 8, 2020
(86) PCT No.: PCT/CA2020/050946

§ 371 Date: Jan. 4, 2022

(30) Foreign Application Priority Data
Jul. 8, 2019 (GB) 1909771.6

(51) Int. Cl. A01N 43/90; A01P 5/00

(52) U.S. Cl. CPC A01N 43/90; A01P 5/00

(57) ABSTRACT

The present application relates to the treatment of nematode infections in a plant. For example, the application relates to the use of one or more compounds of Formula (I) as defined herein, or compositions comprising these compounds, for treatment of a nematode infection or a disease, disorder or condition arising from a nematode infection in a plant.

### RELATED APPLICATIONS

The present application claims the benefit of priority of co-pending United Kingdom patent application no. 1909771.6 filed on Jul. 8, 2019, the contents of which are incorporated herein by reference in their entirety.

### FIELD

The present application relates to the treatment of nematode infections in plants. For example, the application relates to the use of one or more compounds as disclosed herein for treatment of a nematode infection or a disease, disorder or condition arising from a nematode infection in a plant.

### INTRODUCTION

In the coming years, global food demands will be challenging to meet as the human population rises¹⁻⁵. By the year 2050, the global population is expected to grow 30% to reach 9.8 billion people⁶, and as developing nations incorporate more sugar, protein, and animal fats in their diets a corresponding increase in per-capita consumption is anticipated as well^{1, 4, 7}. To further complicate matters, there is a scarcity of arable land for agricultural expansion, and the prospects for land conversion are constrained by social and ecological factors^{3, 4, 7-9}. Increasing production from currently cultivated land will therefore be crucial to ensure global food security^{2, 4, 5, 9}.

Pest organisms and pathogens that damage crops and livestock severely limit the production capacity of farmed land^{7, 10, 11}. In particular, parasitic nematodes are especially destructive agricultural pathogens that infect numerous commercially valuable plants and animals¹¹⁻¹⁹. Nematode infections of livestock cause significant morbidity and mortality, resulting in global losses to farmers of $10 billion or more annually^{11, 16-18}, and plant-parasitic nematodes (PPNs) are estimated to cause upwards of $358 billion in crop losses every year²⁰⁻²². PPNs can be particularly devastating—reducing crop yields by well over 80% in some cases¹⁹. In particular, the plant-parasitic root-knot nematode Meloidogyne incognita, owing to its broad host range and vast global distribution, is arguably the world's most damaging plant pathogen^{12, 14, 40, 41}. To make matters worse, as the climate warms, the rate at which agriculturally damaging species eat and grow will accelerate²³, further intensifying the threat to our food sources.

For decades small-molecule nematicides and anthelmintics have played a central role in the nematode control programs of farmers worldwide, and remain a dominant strategy for managing parasitic nematode infections of crops and livestock^{21, 22, 24-26}. At the turn of the century, concerns over environmental toxicity and human safety justifiably prompted restrictions and bans on the nematicides most commonly used against PPNs²⁷⁻³⁰. The affected compounds include the ozone-depleting fumigant methyl bromide, as well as many of the neurotoxic organophosphate and carbamate nematicides. Though warranted, these stricter regulations have limited the number of available nematicides to the point that for several nematode threats there are no control options^{26, 27}. Despite the need for safer and more eco-friendly nematocidal compounds, only a handful of non-fumigant nematicides have been commercialized in the past decade³¹⁻³⁶. Regrettably, the situation for animal health is similar. Nematode resistance has been reported in the field for the vast majority of anthelmintic drugs used to treat infected livestock^{24, 37-39} casting doubt on the long-term utility of an already limited pool of therapies.

Studies have shown that some anthelmintics are active in only a subset of nematode species. For example, multiple studies report that the nematicides benomyl and thiabendazole, the latter of which is a commonly used drug to treat human strongyloides infections, are ineffective against plant-parasitic root-knot nematodes⁶⁷⁻⁶⁹. It has also been shown that albendazole, which is a commonly used drug to treat human ascaris infections, is potently active against the parasitic nematode A. ceylanicum but that it is inactive in the parasitic nematode H. bakeri both in vitro and in vivo⁷⁰.

Additionally, studies have also shown that some animal-based anthelmintics require bioactivation in vivo to provide the metabolite responsible for their activity. Such anthelmintics would not be expected to be active against plant-parasitic nematodes which do not associate with animal hosts and therefore would not be capable of bioactivating the anthelmintics. For example, the discovery of the commercial anthelmintic tetramisole provides compelling evidence in support of this point⁷¹. In brief, the authors screened chemicals for anthelmintic activity in chickens infected with parasitic nematodes, and from this primary screen, and follow-up experiments, they found that subtoxic doses of thiazathienol were active against multiple intestinal nematodes in chicken and sheep, but inactive in mice and rats. It was found that chicken and sheep metabolize thiazathienol to the active agent in vivo, but mice and rats are incapable of this biotransformation. The subsequent testing of numerous structural derivatives of the bioactive metabolite identified tetramisole as a potent and broad-spectrum anthelmintic, effective in all host animals tested. Thus, in this example, the anthelmintic is bioactivated by the host animal, and would have negligible activity on its own. In vitro anthelmintic activity would not be expected for a compound that is bioactivated in vivo. Plant-parasitic nematodes do not associate with animal hosts, so if the anthelmintic requires bioactivation by a mammalian host then activity against plant-parasitic nematodes would not be expected.

Japanese patent JP 49006099 describes a series of 6-aryl-imidazo[2,1-b]thiazole compounds as being active against Ascaris infections in dogs. Ascarids are intestinal nematode parasites of animals and no in vitro activity or activity against plant-parasitic nematodes is reported for the disclosed compounds.

### SUMMARY

Imidazothiazole compounds have been identified that incapacitate the plant-parasitic root-knot nematodes Meloidogyne incognita and/or Meloidogyne chitwoodi. These compounds show little-to-no activity in non-target systems such as zebrafish and mice. This suggests that the imidazothiazole compounds of the application are target (nematode) specific. These compounds also show no genetic resistance. This suggests that resistance to these compounds will be less likely to develop in the wild.

Accordingly, the present application includes a method for treating or preventing a nematode infection in a plant comprising administering to a plant in need thereof, an effective amount of one or more compounds of Formula (I)

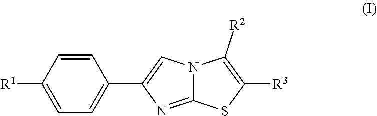

and/or solvates thereof,
wherein:
R¹ is selected from H and halo, and
R² and R³ are independently selected from H and C₁₋₄alkyl.

The present application also includes a method of treating or preventing a disease, disorder or condition in a plant arising from a nematode infection comprising administering an effective amount of one or more compounds of the application and/or solvates thereof to a plant in need thereof.

The present application also includes a composition comprising one or more carriers and one or more compounds of the application and/or solvates thereof.

The present application includes a method of treating or preventing a nematode infection or a disease, a disorder, or a condition arising from a nematode infection comprising administering one or more compositions of the application to a plant in need thereof.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### DRAWINGS

The embodiments of the application will now be described in greater detail with reference to the attached drawings in which:

FIG. 1(A) shows the chemical structure of exemplary compounds of the application that were tested. For each exemplary compound of the application, the lethal concentration required to kill 50% (LC₅₀) of C. elegans first-stage larvae (L1) is shown. FIG. 1(B) shows the dose-response of each C. elegans developmental stage to exemplary compound Ia and exemplary compound Ic. The fraction of worms that were viable at each concentration, relative to the dimethyl sulfoxide (DMSO) solvent control, is plotted for each concentration tested. Four-parameter logistic curves were fitted to the dose-response data by non-linear regression, from which LC₅₀ values were extracted. The LC₅₀ values at each developmental stage are indicated. The results in FIGS. 1(A) and 1(B) show that the exemplary compounds of the application can kill C. elegans at each developmental stage.

FIG. 2 shows results of dose-response assays for exemplary compounds of the application on the root-knot nematode M. incognita. The effects of the exemplary compounds of the application on M. incognita infective juveniles was quantified as the percent of worms active after 1 and 2 days of chronic exposure to the compounds, and on the third day after rinsing the chemicals away with water a day earlier. The results from each different day are plotted in separate graphs, and the corresponding day is indicated at the top of the graph. Water and DMSO controls, as well as each of the chemical treatments and the concentrations tested, are indicated on the x-axes of the graphs. The percent of worms active is indicated on the y-axes. Abbreviations: Fluo, fluopyram; Tiox, tioxazafen. The results show that some exemplary compounds of the application kill the root-knot nematode M. incognita more potently than the commercial nematicide tioxazafen.

FIG. 3 shows the effects of the exemplary compounds of the application on the greening of Arabidopsis thaliana plants as they grow under light. The exemplary compounds of the application, and the two known nematicides, Tioxazafen and Fluopyram, were tested at 5, 15, and 45 micromolar concentrations.

### DESCRIPTION

### 1. Definitions

Unless otherwise indicated, the definitions and embodiments described in this and other sections are intended to be applicable to all embodiments and aspects of the present application herein described for which they are suitable as would be understood by a person skilled in the art.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

The term “consisting” and its derivatives, as used herein, are intended to be closed terms that specify the presence of the stated features, elements, components, groups, integers, and/or steps, but exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

As used in this application, the singular forms “a”, “an” and “the” include plural references unless the content clearly dictates otherwise. For example, an embodiment including “a compound” should be understood to present certain aspects with compound or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “compound(s) of the application” and the like as used herein refers to a compound of Formula (I) and/or solvates thereof.

The term “composition of the application” or “composition of the present application” and the like as used herein refers to a composition comprising one or more compounds of the application.

The present description refers to a number of chemical terms and abbreviations used by those skilled in the art. Nevertheless, definitions of selected terms are provided for clarity and consistency.

The term “alkyl” as used herein, whether it is used alone or as part of another group, means straight or branched chain, saturated alkyl groups. The number of carbon atoms that are possible in the referenced alkyl group are indicated by the prefix “Cₙ₁₋ₙ₂”. For example, the term C₁₋₁₀alkyl means an alkyl group having 1, 2, 3, 4, 5, 6, 7, 8, 9 or 10 carbon atoms.

The term “halo” or “halogen” as used herein refers to a halogen atom and includes fluoro, chloro, bromo and iodo.

The term “solvate” as used herein means a compound, or a salt or prodrug of a compound, wherein molecules of a suitable solvent are incorporated in the crystal lattice.

The term “nematode” as used herein refers to a worm of the phylum Nematoda.

The expression “disease, disorder or condition arising from a nematode infection” as used herein refers to any disease, disorder or condition that is directly or indirectly caused by the presence of a nematode infection in a plant.

The term “plant” as used herein refers to any species or genera of plant that may be the target of infection by a nematode. The term “plant” also refers to any part of the plant, including, for example, seeds, roots, stems, flowers and leaves.

The term “nematode infection” as used herein refers to an invasion of any part of a plant by a foreign undesirable nematode.

The term “anthelmintic” or “anthelmintics” as used herein refers to a group of antiparasitic drugs used in the treatment and prevention of nematode infections in animals.

As used herein, a compound with “nematicidal activity” or “nematicide” is a compound, which when tested, has measurable nematode-killing activity or results in sterility or reduced fertility in the nematodes such that fewer viable or no offspring result, or compromises the ability of the nematode to infect or reproduce in its host, or interferes with the growth or development of a nematode. The compound may also display nematode repellant properties.

The term “nematicidal composition” as used herein refers to a composition of matter for treating one or more nematode infections.

The term “carrier” as used herein means an inert compound with which the composition is mixed or formulated. The term “carrier” includes, for example, solid or liquid carriers or combinations thereof.

The term “administered”, “administering”, “application” or “applied” as used herein means administration of an effective amount of a compound, including compounds of the application, to a plant. Administration may be direct to any part of the plant, including seeds, roots, stems, flowers and leaves, or indirect, including administration to the environment around any part of the plant.

As used herein, the term “effective amount” or “therapeutically effective amount” means an amount effective, at dosages and for periods of time necessary to achieve a desired result. For example, in the context of treating a nematode infection, or a disease, disorder or condition arising from a nematode infection, an effective amount of a compound is an amount that, for example, reduces the nematode infection compared to the nematode infection without administration of the compound. By “reducing the infection”, it is meant, for example, reducing the amount of the infectious agent in the plant and/or reducing the symptoms of the infection. The amount of a given compound or composition that will correspond to such an amount will vary depending upon various factors, such as the given compound or composition, the formulation, the route of administration, the type of condition, disease or disorder, the identity of the plant being treated, and the like, but can nevertheless be routinely determined by one skilled in the art.

The terms “to treat”, “treating” and “treatment” as used herein and as is well understood in the art, means an approach for obtaining beneficial or desired results, including clinical results. Beneficial or desired clinical results include, but are not limited to, diminishment of extent of nematode infection, stabilization (i.e. not worsening) of the state of the nematode infection, preventing spread of the nematode infection, delay or slowing of infection progression, amelioration or palliation of the nematode infectious state, diminishment of the reoccurrence of nematode infection, diminishment, stabilization, alleviation or amelioration of one or more diseases, disorders or conditions arising from the nematode infection, diminishment of the reoccurrence of one or more diseases, disorders or conditions arising from the nematode infection, and remission of the nematode infection and/or one or more symptoms or conditions arising from the nematode infection, whether partial or total, whether detectable or undetectable. “To treat”, “treating” and “treatment” can also mean prolonging survival as compared to expected survival if not receiving treatment. “To treat”, “treating” and “treatment” as used herein also include prophylactic treatment. For example, a plant with an early nematode infection is treated to prevent progression, or alternatively a plant in remission is treated to prevent recurrence.

“Palliating” an infection, disease, disorder and/or condition means that the extent and/or undesirable manifestations of an infection, disease, disorder and/or condition are lessened and/or time course of the progression is slowed or lengthened, as compared to not treating the infection, disease, disorder and/or condition.

The term “prevention” or “prophylaxis” and the like as used herein refers to a reduction in the risk or probability of a plant becoming afflicted with a nematode infection and/or a disease, disorder and/or condition arising from a nematode infection or manifesting a symptom associated with a nematode infection and/or a disease, disorder and/or condition arising from a nematode infection.

### II. Methods and Uses of the Application

Imidazothiazole compounds have been identified that incapacitate the plant-parasitic root-knot nematode Meloidogyne incognita and/or Meloidogyne chitwoodi. These compounds show little-to-no activity in non-target systems such as zebrafish and mice. This suggests that the imidazothiazole compounds of the application are target (nematode) specific. These compounds also show no genetic resistance. This suggests that resistance to these compounds will be less likely to develop in the wild.

Accordingly, the present application includes a method of treating or preventing a nematode infection in a plant comprising administering to a plant in need thereof, an effective amount of one or more compounds of Formula (I)

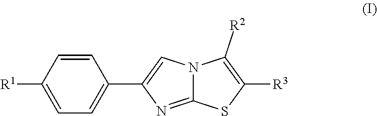

and/or solvates thereof,
wherein:
R¹ is selected from H and halo, and
R² and R³ are independently selected from H and C₁₋₄alkyl.

The application also includes a use of one or more compounds of the application and/or solvates thereof for treating or preventing a nematode infection in a plant. The application further includes one or more compounds of the application and/or solvates thereof for use for treating or preventing a nematode infection in a plant.

The present application also includes a method of treating or preventing a disease, disorder or condition in a plant arising from a nematode infection comprising administering an effective amount of one or more compounds of the application and/or solvates thereof to a plant in need thereof.

The application also includes a use of one or more compounds of the application and/or solvates thereof for treating or preventing a disease, disorder or condition in a plant arising from a nematode infection. The application further includes one or more compounds of the application and/or solvates thereof for use for treating or preventing a disease, disorder or condition arising from a nematode infection in a plant.

In some embodiments, R¹ in the compounds of Formula (I) is halo. In some embodiments, R¹ is selected from Cl, F and Br. In some embodiments, R¹ is Cl. In some embodiments, R¹ is H. In some embodiments, R² and R³ in the compounds of Formula (I) are independently selected from H, CH₃, CH₂CH₃, CH(CH₃)₂ and C(CH₃)₃. In some embodiments, R² and R³ are independently selected from H and CH₃. In some embodiments, one of R² and R³ is H and the other is CH₃. In some embodiments, R² and R³ are both H. In some embodiments, R² and R³ are both CH₃.

In some embodiments, the one or more compounds Formula (I) is selected from

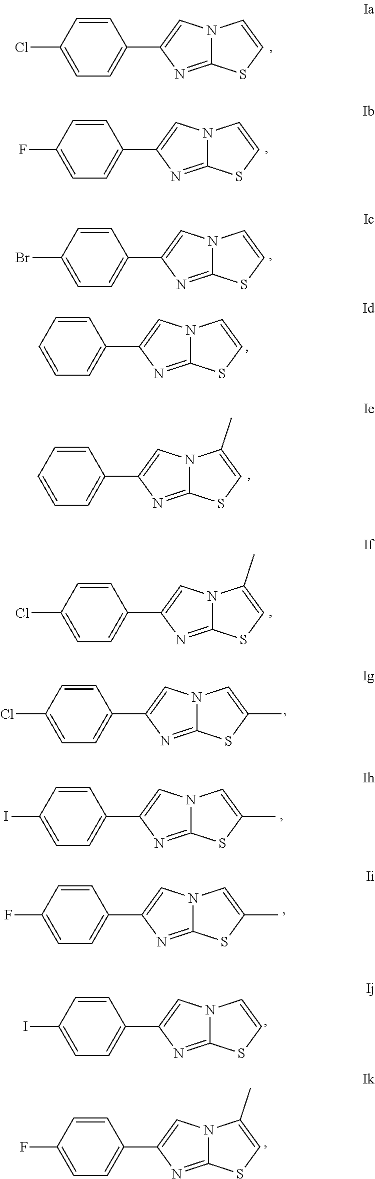

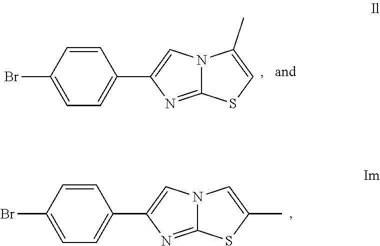 [SMILES: Cc1csc2nc(-c3ccc(Br)cc3)cn12 ; Cc1cn2cc(-c3ccc(Br)cc3)nc2s1]

and/or solvates thereof.

In some embodiments, one or more compounds of Formula (I) is selected from

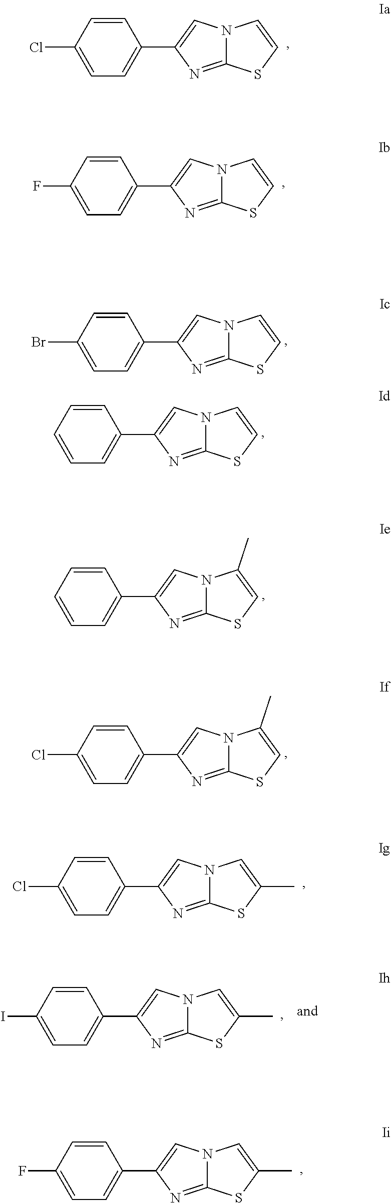

and/or solvates thereof.

In some embodiments, one or more compounds of Formula (I) is selected from

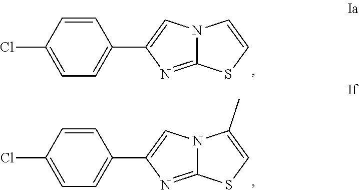

### If, and

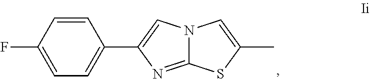 [SMILES: Cc1cn2cc(-c3ccc(F)cc3)nc2s1]

and/or solvates thereof.

In some embodiments, the one or more compounds of Formula (I) is selected from

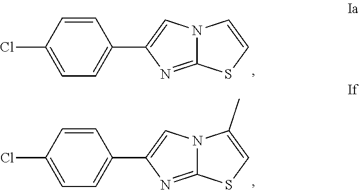

and/or solvates thereof.

In some embodiments, the compound of Formula (I) is

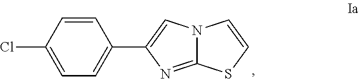 [SMILES: Clc1ccc(-c2cn3ccsc3n2)cc1]

and/or solvates thereof.

In some embodiments, the compound of Formula (I) is

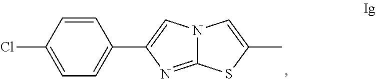 [SMILES: Cc1cn2cc(-c3ccc(Cl)cc3)nc2s1]

and/or solvates thereof.

In some embodiments, the nematode infection is an infection of an endoparasitic nematode. In some embodiments, the nematode infection is an infection of an ectoparasitic nematode.

In some embodiments, the nematode infection is an infection of a nematode selected from the following genera: Meloidogyne, Heterodera, Globodera, Pratylenchus, Rotylenchulus, Hoplolaimus, Bolonolaimus, Longidorus, Paratrichodorus, Ditylenchus, Bursaphalencus, Xiphinema, Nacobbus, Aphelenchoides, Helicotylenchus, Radopholus, Hirschmanniella, Tylenchorhynchus, Trichodorus, Anguina, Criconema, Criconemella, Criconemoides, Mesocriconema, Dolichodorus, Hemicycliophora, Hemicriconemoides, Scutellonema, Tylenchulus, Subanguina, Hypsoperine, Macroposthonia, Melinius, Punctodera, and Quinisulcius.

In some embodiments, the nematode infection is an infection of a nematode of the genus Meloidogyne.

In some embodiments, the infection of a nematode of the genus Meloidogyne is an infection of a nematode belonging to the species Meloidogyne incognita.

In some embodiments, the infection of a nematode of the genus Meloidogyne is an infection of a nematode belonging to the species Meloidogyne chitwoodi.

The compounds of the application useful in the present application are available from commercial sources or can be prepared using methods known in the art. For example, some of the compounds of the application can be purchased from ChemBridge Corporation, Life Chemicals and MolPort.

In some embodiments, the compounds of the application are prepared as shown in Scheme 1:

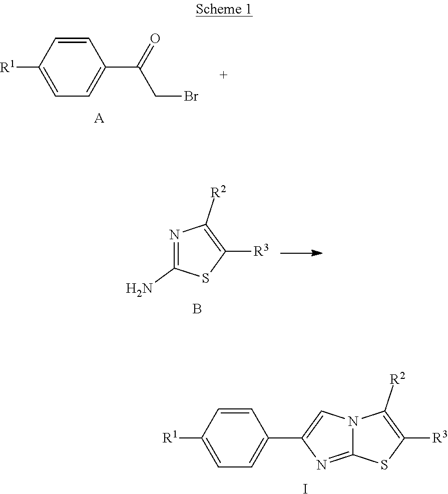

Therefore various α-bromoketones of Formula A, wherein R¹ is as defined in Formula I, are reacted with excess amounts of aminothiazoles of Formula B, wherein R² and R³ are as defined in Formula I, in a suitable solvent, such as a polar organic solvent, under conditions to provide the compounds of Formula I. In some embodiments, the conditions to provide the compounds of Formula I are refluxing conditions until the disappearance of the α-bromoketone is evident by TLC.

In some embodiments, α-bromoketones of Formula A, wherein R¹ is as defined in Formula I, are prepared as shown in Scheme 2:

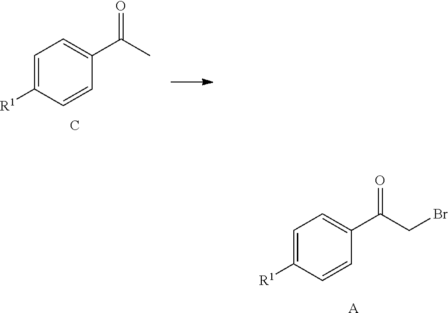

Therefore 4-substituted acetophenones of Formula C, wherein R¹ is as defined in Formula I, are brominated, for example by reaction with N-bromosuccinimide, in the presence of an acid, such as p-toluene sulfonic acid in a suitable organic solvent to provide compounds of Formula A, wherein R¹ is as defined in Formula I.

Compounds of Formula B, wherein R² and R³ are as defined in Formula I, and C, wherein R¹ is as defined in Formula I, are either commercially available or prepared using methods known in the art.

Examples of suitable solvate solvents are ethanol, water and the like. When water is the solvent, the molecule is referred to as a “hydrate”. The formation of solvates will vary depending on the compound and the solvate. In general, solvates are formed by dissolving the compound in the appropriate solvent and isolating the solvate by cooling or using an antisolvent. The solvate is typically dried or azeotroped under ambient conditions. The selection of suitable conditions to form a particular solvate can be made by a person skilled in the art.

When used, for example, with respect to the methods of treatment, uses, compositions and kits of the application, a plant, for example a plant “in need thereof” is a plant that has been diagnosed with, is suspected of having, may come in to contact with, and/or was previously treated for a nematode infection or a disease, disorder or condition arising from a nematode infection. In some embodiments, the plant is a cultivated plant. In some embodiments, the plant is an agricultural crop plant. In some embodiments, the plant includes, but is not limited to, soybeans, cotton, flax, hemp, jute, corn, tobacco, nuts, almonds, coffee, tea, pepper, grapevines, hops, wheat, barley, rye, oats, rice, maize, sorghum, apples, pears, plums, peaches, banana, plantains, cherries, strawberries, raspberries, blackberries, beans, lentils, peas, soya, oilseed rape, mustard, poppies, olives, sunflowers, coconut, castor, cocoa, ground nuts, spinach, asparagus, lettuce, cabbages, carrots, onions, tomatoes, potatoes, bell peppers, cucumbers, melons, pumpkins, sugar cane, sugar beet, fodder beet, avocado, cinnamonium, camphor, oranges, tangerines, lemons, limes, grapefruit, latex plants, ornamental plants, and/or turf grasses.

In some embodiments, the disease, disorder or condition arising from a nematode infection includes, but is not limited to, stunted growth, bulb discolouration, swollen stems, root knots (or galls), root cysts, root lesions, root necrosis, toppling (or blackhead disease), and pine wilt, for example.

When used, for example, in respect to plant treatments, the compounds of the application and/or solvates thereof may be delivered by several means including pre-planting, post-planting and as a feed additive, drench, or external application.

In some embodiments, the methods and uses of the application comprise applying to the plant, to the soil surrounding the plant, and/or to the seeds of the plant an effective amount of one or more compounds of the application. In some embodiments, the applying is by foliar application, for example by spraying an effective amount of one or more compounds of the application at least on to the plant leaves. In some embodiments, the applying is to the seeds of the plant, for example, as a seed coating.

In the context of treating or preventing a nematode infection or a disease, disorder or condition caused by a nematode infection, an effective amount of the one or more compounds of the application and/or solvates thereof, is an amount that, for example, reduces the amount of infection by the nematode in the plant compared to the amount of infection by the nematode in the plant without administration of the one or more compounds of the application. Reducing the amount of infection may be assessed, for example, by detecting an amount of viable or living nematodes in the plant, and/or by observing or assessing the extent of a disease, disorder or condition caused by a nematode infection.

The dosage of the one or more compounds of the application and/or solvates thereof, varies depending on many factors such as the pharmacodynamic properties thereof, the mode of administration, the age, health and weight/mass of the plant, the nature and extent of the symptoms, the frequency of the treatment and the type of concurrent treatment, if any. One of skill in the art can determine the appropriate dosage based on the above factors. The one or more compounds of the application and/or solvates thereof may be administered initially in a suitable dosage that may be adjusted as required, depending on the response.

Treatment methods comprise administering to a plant one or more compounds of the application and/or solvates thereof, and optionally consists of a single administration, or alternatively comprises a series of administrations. The length of the treatment period depends on a variety of factors, such as the severity of the infection, disease, disorder or condition, the age and size of the plant, the dosage of the one or more compounds of the application, the activity of one or more compounds of the application, or a combination thereof.

In some embodiments, the one or more compounds of the application are administered or used as soon as possible after exposure to the nematode. In some embodiments, the one or more compounds of the application are administered or used until treatment of the nematode infection, disease disorder or condition is achieved. For example, until complete elimination of the nematode is achieved, or until the number of nematode has been reduced to the point where the plant's defenses are no longer overwhelmed and can kill any remaining nematode.

In some embodiments, the present application includes methods of reducing the viability or fecundity or slowing the growth or development or inhibiting the infectivity of a nematode using one or more compounds of the application.

In some embodiments, the present application includes methods of reducing the viability or fecundity or slowing the growth or development or inhibiting the infectivity of a nematode using a compound of the application, the methods comprising administering an effective amount of one or more compounds of the application to a plant.

In some embodiments, the one or more compounds of the application and/or solvates thereof are applied to plants at any suitable rate, the selection of which can be made by a person skilled in the art. Factors to consider include, for example, the identity of the plant, the identity of the nematode, the identity of the plant disease, disorder or condition, the severity of the nematode infection, the severity of the plant disease, disorder or condition, the age of the plant, the activity of the one or more compounds of the application and the concentration of the one or more compounds of the application, or a combination thereof.

In some embodiments, the foliage of the plant and/or the soil surrounding the plant is contacted with the one or more compounds of the application and/or solvates thereof.

In some embodiments, the nematode infects plants and the one or more compounds are administered to the soil or to plants. In some embodiments, the one or more compounds are administered to soil before planting. In some embodiments, the one or more compounds are administered to soil after planting. In some embodiments, the one or more compounds are administered to soil using a drip system. In some embodiments, the one or more compounds are administered to soil using a drench system. In some embodiments, the one or more compounds are administered to plant roots or plant foliage (e.g., leaves, stems). In some embodiments the one or more compounds are tilled into the soil or administered in furrow. In some embodiments, the one or more compounds are administered to seeds. In some embodiments, the one or more compounds are applied as a seed coating.

It will also be appreciated that the effective amount of the one or more compounds of the application and/or solvates thereof used for the administration or use may increase or decrease over the course of a particular regime. In some instances, chronic administration or use is required. In some embodiments, the one or more compounds of the application are administered or used in an amount and for a duration sufficient to control a disease, disorder or condition or eliminate the disease, disorder or condition caused by the plant nematode. In some embodiments, the one or more compounds of the application are administered or used in an amount and for a duration sufficient to control a nematode infection or eliminate the nematode infection in a plant.

The one or more compounds of the application are used either used alone or in combination with other known agents useful for treating or preventing a nematode infection or a disease, disorder or condition arising from a nematode infection. When used in combination with other agents useful for treating a nematode infection or a disease, disorder or condition arising from a nematode infection, it is an embodiment that the one or more compounds of the application are administered contemporaneously with those agents. As used herein, “contemporaneous administration” of two substances to a subject means providing each of the two substances so that they are both active in the plant at the same time.

Compounds can be tested for nematicidal activity using methods known in the art. For example, the compound is combined with nematodes, e.g., in a well of microtiter dish, in liquid or solid media or in the soil containing the agent. Staged nematodes are placed on the media. The time of survival, viability of offspring, and/or the movement of the nematodes are measured. An agent with “nematicidal activity” can, for example, reduce the survival time of adult nematodes relative to unexposed similarly staged adults, e.g., by about 20%, 40%, 60%, 80%, or more. In the alternative, an agent with “nematicidal activity” may also cause the nematodes to cease replicating, regenerating, and/or producing viable progeny, e.g., by about 20%, 40%, 60%, 80%, or more. The effect may be apparent immediately or in successive generations.

### III. Compositions of the Application

A compound of the application is suitably used on their own but will generally be administered in the form of a composition in which the one or more compounds of the application (the active ingredient) are suitably formulated in a conventional manner into compositions using one or more carriers. Accordingly, the present application also includes a composition for treating or preventing a nematode infection or a disease, a disorder, or a condition arising from a nematode infection in a plant comprising an effective amount of one or more compounds of the application, and one or more carriers. In some embodiments, the one or more compounds of the application are present in an amount that is effective to treat or prevent a nematode infection or a disease, a disorder, or a condition arising from a nematode infection.

In some embodiments, the present application includes a method of treating or preventing a nematode infection or a disease, a disorder, or a condition arising from a nematode infection comprising administering one or more compositions of the application to a plant in need thereof.

In some embodiments, the present application also includes a use of one or more compositions of the application for treating or preventing a nematode infection or a disease, a disorder, or a condition arising from a nematode infection in a plant in need thereof. The present application also includes a use of one or more compositions of the application for preparation of a medicament for treating or preventing a nematode infection or a disease, a disorder, or a condition arising from a nematode infection in a plant in need thereof. Also included is one or more compositions of the application for use to treat or prevent a nematode infection or a disease, a disorder, or a condition arising from a nematode infection in a plant in need thereof.

In some embodiments, the one or more carriers are selected from any solid or liquid carrier that is compatible with the treatments of plants.

In some embodiments, the one or more carriers is one or more agricultural excipients or one or more solvents or combinations thereof.

In some embodiments, the one or more solvents is any solvent that is compatible or suitable for the treatment of plants, such as water. In some embodiments, the solvent comprises a mixture of one or more solvents.

In some embodiments, the composition of the application is a liquid concentrate that will be diluted, for example with water, prior to use (e.g. prior to application to plants). Dilution amounts will depend, for example on the type of plant and the size of the area to be treated, and can be readily determined by a person skilled in the art. In some embodiments, the concentrate is diluted to apply or administer an effective amount of the one or more compounds of the application to the plant.

In some embodiments, the composition is a solid composition that is reconstituted or dissolved in one or more solvents, such as water, prior to use (e.g., prior to application to plants).

In some embodiments, the solid composition is reconstituted or dissolved in one or more solvents to apply or administer an effective amount of the one or more compounds of the application to the plant.

In some embodiments, depending on the mode of administration, the composition will comprise from about 0.05 wt % to about 99.95 wt % or about 0.10 wt % to about 70 wt %, of the one or more compounds of the application, and from about 1 wt % to about 99.95 wt % or about 30 wt % to about 99.90 wt % of the carrier, all percentages by weight being based on the total composition.

In some embodiments, the composition of the application is a ready to use composition and the amount of the one or more compounds of the application in the composition is about 0.001 μM to about 100 mM, 0.01 μM to about 10 mM, 0.1 μM to about 500 μM, about 1.0 μM to about 250 μM, or about 5.0 μM to about 100 μM.

In some embodiments, the one or more agricultural excipients is a surfactant, a permeation enhancer, a co-solvent, a fertilizer, a wetting agent, a sticker/spreader, a stabilizer, or an emulsifier.

For example, in some embodiments, the compositions of the application may comprise one or more aqueous surfactants. Examples of surfactants that can be used include, Span 20, Span 40, Span 80, Span 85, Tween 20, Tween 40, Tween 80, Tween 85, Triton X 100, Makon 10, Igepal CO 630, Brij 35, Brij 97, Tergitol TMN 6, Dowfax 3B2, Physan and Toximul TA 15, and mixtures thereof. In some embodiments, the surfactant is a cationic surfactant. In another embodiment of the present application, the cationic surfactant is cetyltrimethylammonium chloride.

In some embodiments, the compositions of the application may comprise a one or more permeation enhancers (e.g., cyclodextrin).

In some embodiments, the compositions of the application may comprise one or more co-solvents. Examples of co-solvents that can be used include ethyl lactate, methyl soyate/ethyl lactate co-solvent blends (e.g., Steposol), isopropanol, acetone, 1,2-propanediol, n-alkylpyrrolidones (e.g., the Agsolex series), a petroleum based-oil (e.g., aromatic 200) or a mineral oil (e.g., paraffin oil), or mixtures thereof.

In some embodiments, the compositions of the application may comprise one or more other pesticides (e.g., nematicide, insecticide or fungicide) such as an avermectin (e.g., abamectin), milbemycin, imidacloprid, aldicarb, oxamyl, fenamiphos, fosthiazate, metam sodium, etridiazole, penta-chloro-nitrobenzene (PCNB), flutolanil, metalaxyl, mefonoxam, fosetyl-al, fluensulfone, fluopyram, fluazaindolizine, iprodione, spirotetramat, and tioxazafen, or mixtures thereof. Useful fungicides include, but are not limited to, silthiofam, fludioxonil, myclobutanil, azoxystrobin, chlorothalonil, propiconazole, tebuconazole, pyraclostrobin, fluopyram and iprodione, or mixtures thereof. In some embodiments, the compositions of the application may also comprise one or more herbicides (e.g., trifloxysulfuron, glyphosate, halosulfuron) and/or other chemicals for disease control (e.g., chitosan).

In some embodiments, the compositions of the present application may comprise one or more fertilizers. In some embodiments, the fertilizer comprises primary, secondary and tertiary nutrients, for example nitrogen, phosphorous, potassium, calcium, magnesium, sulfur, zinc, manganese, iron, copper molybdenum, boron, cobalt, nickel and silicon.

In some embodiments, the compositions of the present application may comprise one or more wetting agents. In some embodiments, the wetting agent is an alcohol ethoxylate, alkylphenol ethoxylate, fatty acid ethoxylate, fatty acid ester or silicone polymer, or a mixture thereof.

In some embodiments, the compositions of the present application may comprise one or more stabilizers/emulsifiers. In some embodiments, the stabilizer/emulsifier is a polysaccharide or protein, or a mixture thereof. In another embodiment the stabilizer/emulsifier is guar gum.

In some embodiments, the compositions of the present application may comprise one or more stickers or spreaders.

In some embodiments, the compositions of the application optionally include further components. For example, inorganic bases such as an alkali metal hydroxide (e.g. potassium or sodium hydroxide), an alkali metal carbonate (e.g. potassium or sodium carbonate) or an alkali metal bicarbonate (e.g. sodium or potassium bicarbonate) can be used in combination with the amine to provide a composition with a desired pH.

In some embodiments, the compositions of the present application further include one or more additional acids (for example inorganic acids such as phosphoric acid or organic acids such as acetic acid), for example to provide a composition with a desired pH.

In some embodiments, the composition is prepared by a method comprising mixing the one or more compounds of the application, and optionally, the further components with one or more carriers under conditions to obtain the composition.

In some embodiments, the present application includes a kit for preventing and/or treating a nematode infection or a plant disease caused by a plant infection by a nematode comprising one or more compounds or compositions of the application; and instructions for administration of the one or more compounds or compositions of the application, to a plant in need thereof.

In some embodiments the instructions for administration comprise details for diluting, reconstituting or dissolving the one or more compositions of the application so that an effective amount of the one or more compounds of the application, are administered to the plant. In some embodiments the instructions for administration comprise details for preparing one or more compositions of the application, and optionally, diluting, reconstituting or dissolving the one or more compositions of the application so that an effective amount of the one or more compounds of the application, are administered to the plant.

In some embodiments, the one or more compositions of the application are applied to plants at any suitable rate, the selection of which can be made by a person skilled in the art. Factors to consider include, for example, the identity of the plant, the identity of the nematode, the identity of the plant disease, disorder or condition, the severity of the nematode infection, the severity of the plant disease, disorder or condition, the age of the plant, the concentration of the composition of the application and/or a combination thereof. For example, plants that are planted in rows (row crops) tend to use smaller volumes of water, therefore application rates for a row crop may be about 0.5 L to about 1 L of a composition diluted in about 10 L to about 80 L of water per acre. For vegetable crops application rates may be about 1 L to about 2 L of a composition in about 40 L to about 100 L of water per acre. In some embodiments, the compositions of the present application are applied 1 to 10 times, 2 to 8 times or 4 to 6 times. In some embodiments, about 0.1 L to about 2 L of a composition per acre of crop is applied one to 10 times with applications being made at least one day to at least one week apart. In all embodiments, the composition is diluted so that an effective amount, as defined above, of the one or more compounds of the application are applied to the plants.

In some embodiments, the foliage of the plant and/or the soil surrounding the plant is contacted with the one or more compositions of the application.

In some embodiments, the nematode infects plants and the one or more compositions are administered to the soil or to plants. In some embodiments, the one or more compositions are administered to soil before planting. In some embodiments, the one or more compositions are administered to soil after planting. In some embodiments, the one or more compositions are administered to soil using a drip system. In some embodiments, the one or more compositions are administered to soil using a drench system. In some embodiments, the one or more compositions are administered to plant roots or plant foliage (e.g., leaves, stems). In some embodiments the one or more compositions are tilled into the soil or administered in furrow. In some embodiments, the one or more compositions are administered to seeds.

In some embodiments, the one or more compositions are solid or powder and are administered by spreading.

In some embodiments, the methods of the application comprise administering one or more compositions of the application through one or more means selected from pre-planting, post-planting, as a feed additive, a drench and an external application.

It will also be appreciated that the effective amount of the one or more compositions of the application used for the administration or use may increase or decrease over the course of a particular regime. In some instances, chronic administration or use is required. In some embodiments, the one or more compositions of the application are administered or used in an amount and for a duration sufficient to control a disease, disorder or condition or eliminate the disease, disorder or condition caused by the plant nematode. In some embodiments, the one or more compositions of the application are administered or used in an amount and for a duration sufficient to control a nematode infection or eliminate the nematode infection in a plant.

The following non-limiting examples are illustrative of the present application. As is apparent to those skilled in the art, many of the details of the examples may be changed while still practicing the methods, compositions and kits described herein.

### IV. Examples

### Materials

### Free-Living Nematode Strains and Culture Methods

All free-living nematode strains used in this study were obtained from the C. elegans Genetics Center (University of Minnesota). Worms were cultured using standard methods at 20° C. (ref. 58), unless otherwise indicated.

### Commercial Sources

In some embodiments, the compounds of the application useful in the present application are available from commercial sources. Compounds Ia, Ib, Id, Ig, Ih, Ii, and tioxazafen were purchased from ChemBridge Corporation. Compound Ic was purchased from Vitas-M. Compound Ie was purchased from Life Chemicals. Compound If was purchased from MolPort. Levamisole hydrochloride and fluopyram were purchased from Sigma-Aldrich.

### Example 1: Synthetic Methods

In some embodiments, the compounds of the application useful in the present application are available through chemical synthesis. For example, compounds Ik, Il, and Im are accessible through the following methods:

### Step 1: Synthesis of α-Bromoketones

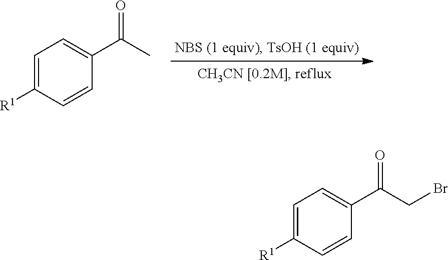

2-bromo-acetophenone analogues were synthesized from the corresponding commercially available acetophenone according to literature procedures⁷⁶.

### Step 2: Synthesis of imidazo[2,1-b]thiazole Compounds

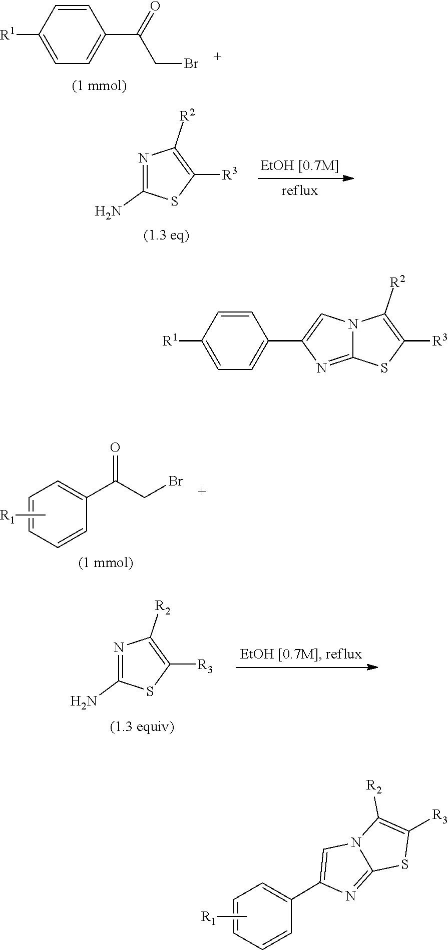

The imidazo[2,1-b]thiazoles were prepared according to a modified literature procedure⁷⁷. To a 2 dram vial was added the α-bromoketone (1 mmol, 1 equiv), 2-aminothiazole (1.3 mmol, 1.3 equiv), and EtOH (3 mL) and the reaction mixture was stirred at reflux until disappearance of the α-bromoketone was evident by TLC. The mixture was concentrated, then purified by column chromatography using the given eluent to provide the imidazo[2,1-b]thiazole.

### 6-(4-fluorophenyl)-3-methylimidazo[2,1-b]thiazole (Compound Ik)

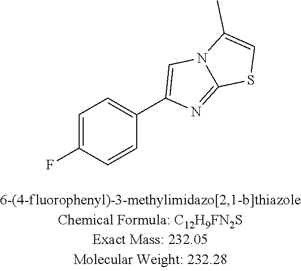 [SMILES: Cc1csc2nc(-c3ccc(F)cc3)cn12]

Purified using pentanes-EtOAc (15:5 v:v). Brown solid (38%, MP=109-114° C.). ¹H-NMR (CDCl₃, 500 MHz): 7.83-7.78 (m, 2H), 7.57 (s, 1H), 7.12-7.05 (m, 2H), 6.42 (q, J=1.3 Hz, 1H), 2.43 (d, J=1.3 Hz, 3H). ¹³C{¹H}-NMR (CDCl₃, 125 MHz): 162.4 (d, J=246.2 Hz), 149.9, 146.9, 130.4, 127.9, 127.0 (d, J=8.0 Hz), 115.7 (d, J=21.6 Hz), 107.0, 105.8, 13.5. ¹⁹F{¹H}-NMR (CDCl₃, 375 MHz): −115.0. IR (neat): 3134, 2965, 2926, 2883, 1750, 1475, 1375, 1155, 1092, 1009, 831, 755, 692. Mass: DART+, calc. for C₁₂H₁₀N₂FS 233.05432 [M+H]⁺, found 233.05424.

### 6-(4-bromophenyl)-3-methylimidazo[2,1-b]thiazole (Compound Il)

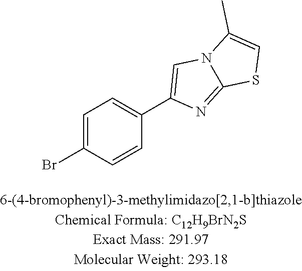 [SMILES: Cc1csc2nc(-c3ccc(Br)cc3)cn12]

Purified using pentanes-EtOAc (16:4 to 15:5 v:v). Orange solid (33%). The spectral data were in accordance with literature⁷⁸. ¹H-NMR (CDCl₃, 500 MHz): 7.73-7.69 (m, 2H), 7.61 (s, 1H), 7.53-7.49 (m, 2H), 6.42 (q, J=1.3 Hz, 1H), 2.42 (d, J=1.3 Hz, 3H). ¹³C{¹H}-NMR (CDCl₃, 125 MHz): 150.1, 146.8, 133.4, 131.9, 127.8, 126.8, 121.2, 107.1, 106.3, 13.5.

### 6-(4-bromophenyl)-2-methylimidazo[2,1-b]thiazole (Compound Im)

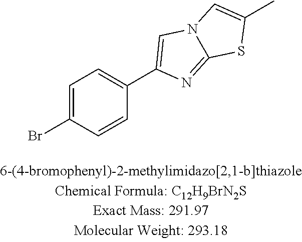 [SMILES: Cc1cn2cc(-c3ccc(Br)cc3)nc2s1]

Purified using pentanes-EtOAc (16:4 to 8:12 v:v). White solid (32%, MP=235-240° C.). ¹H-NMR (CDCl₃, 500 MHz): 7.69-7.64 (m, 2H), 7.61 (s, 1H), 7.52-7.47 (m, 2H), 7.13 (q, J=1.4 Hz, 1H), 2.42 (d, J=1.5 Hz, 3H). ¹³C{¹H}-NMR (CDCl₃, 125 MHz): 150.0, 145.5, 133.2, 131.9, 127.0, 126.7, 121.0, 115.2, 108.0, 14.2. IR (neat): 3134, 2965, 2926, 2883, 1750, 1475, 1375, 1155, 1092, 1009, 831, 755, 692. Mass: DART+, calc. for C₁₂H₁₀N₂SBr 292.97426 [M+H]⁺, found 292.97416.

Work-up and isolation of compounds was performed using standard benchtop techniques. All commercial reagents were purchased from chemical suppliers (Sigma-Aldrich, Combi-Blocks, Alfa Aesar, or Strem Chemicals) and used without further purification. Dry solvents were obtained using standard procedures (THF was distilled over sodium/benzophenone, dichloromethane was distilled over calcium hydride). Reactions were monitored using thin-layer chromatography (TLC) on EMD Silica Gel 60 F254 plates. Visualization was performed under UV light (254 nm) or using potassium permanganate (KMnO₄) or I₂ stain. Flash column chromatography was performed on Siliaflash P60 40-63 μm silica gel purchased from Silicycle. NMR characterization data was obtained at 293K on a Varian Mercury 300 MHz, Varian Mercury 400 MHz, Bruker Advance III 400 MHz, Agilent DD2 500 MHz equipped with a 5 mm Xses cold probe or Agilent DD2 600 MHz. ¹H spectra were referenced to the residual solvent signal (CDCl₃=7.26 ppm, DMSO-d₆=2.50 ppm). ¹³C{¹H} spectra were referenced to the residual solvent signal (CDCl₃=77.16 ppm, DMSO-d₆=39.52 ppm). Data for ¹H NMR are reported as follows: chemical shift (b ppm), multiplicity (s=singlet, d=doublet, t=triplet, q=quartet, m=multiplet), coupling constant (Hz), integration. NMR spectra were recorded at the University of Toronto Department of Chemistry NMR facility. Infrared spectra were recorded on a Perkin-Elmer Spectrum 100 instrument equipped with a single-bounce diamond/ZnSe ATR accessory in the solid state and are reported in wavenumber (cm⁻¹) units. Melting point ranges were done on a Fisher-Johns Melting Point Apparatus and are reported uncorrected. High resolution mass spectra (HRMS) were recorded at the Advanced Instrumentation for Molecular Structure (AIMS) in the Department of Chemistry at the University of Toronto.

### Example 2: Caenorhabditis elegans Chemical Screens

The C. elegans-based chemical screens for new nematicides were performed as previously described⁴⁸. Briefly, 40 μl of a suspension of HB101 E. coli cells in liquid NGM (nematode growth media—see ref. 48 for the recipe) was aliquoted into each well of the 96-well culture plates to be used for screening. The suspension was made by concentrating a saturated overnight HB101 culture 2-fold in liquid NGM. A pinning tool with a 300 μl slot volume was used to pin the library chemicals into each well of the screening plates. Approximately twenty synchronized first-larval stage (L1) worms, in 10 μl of M9 buffer (see ref. 59 for the recipe), were then added to each well. The synchronized L1 worms were obtained from an embryo preparation performed the previous day (see ref. 59 for the protocol). The chemicals in the screening libraries are dissolved in DMSO at a concentration of 10 mM, so the final screening concentration was 60 μM (0.6% DMSO v/v). The worms were allowed to incubate in the chemicals for 6 days at 20° C. Nematicidal compounds were defined as those inducing 100% lethality at the 60 μM screening concentration.

### Example 3: C. elegans Dose-Response Experiments

Forty microliters of an HB101 bacterial suspension in liquid NGM (see above) was added to each well of a 96-well flat-bottom culture plate, after which approximately 25 synchronized L1 worms, in 10 μl of M9 buffer (see ref. 59 for the recipe), were added to each well. The synchronized L1 worms were obtained from an embryo preparation performed the previous day (see ref. 59 for the protocol). For the L1 assays, 0.5 μl of chemical solution (or DMSO alone) was immediately added to the wells using a multichannel pipette, the final DMSO concentration is 1% (v/v). The worms were incubated for 3 days at 20° C. and the number of viable animals was counted. A dead worm was considered any worm that failed to move after vigorous agitation of the plate, and that appeared morphologically “dead”, i.e. clear appearance and unresolved internal structures. Although the counts were performed after 3 days of incubation in the chemical, it was noted that the L1s were dead within 24 hours of the addition of the chemicals. For the L2/L3 assays, the worms were incubated in the absence of chemical for 1 day at 20° C. until they reached the L2/L3 stage, at which point chemical was added as described above. The worms were then allowed to incubate for 2 days at 20° C. and the number of viable animals was counted as described for the L1 assay. For the L4 assays, the worms were incubated for 2 days at 20° C. before the addition of chemicals. The L4-stage worms were then incubated in chemical for an additional day before quantifying the number of viable animals. The adult assays were performed the same way as the L4 assays, however HT115 E. coli carrying the empty dsRNA expressing vector L4440 was used in place of HB101 and the worms were cultured at 25° C. as opposed to 20° C. for the entirety of the experiment. The HT115 suspension was made by concentrating a bacterial culture, with an OD600 of ˜ 0.8, five-fold with liquid NGM containing 1 mM IPTG and 100 μg/ml carbenicillin. The HT115 cells were induced with 1 mM IPTG for one hour before concentrating with NGM.

For the dose-response experiments with embryos, eggs obtained from an embryo preparation were immediately aliquoted into 96-well plate wells. Approximately 25 embryos in 50 μl of M9 buffer were added to each well, and 0.5 μl volumes of the chemicals were added via multichannel, in the same way as for the L1 dose-response assays described above. The plates were incubated at 20° C. for 1 day, at which point the number of hatched eggs was counted. An egg was considered dead if it failed to hatch.

For the dauer dose-response assays, the CB1370 strain carrying the temperature sensitive daf-2(e1370) allele was used. When grown at the non-permissive temperature of 25° C. these mutants will enter dauer constitutively. The assay was performed similarly to the L4 assay described above, however the L1 worms were allowed to grow for 2 days at 25° C. until they became dauer larvae. At this point chemical was added and the dauers were incubated for 2 days at 25° C. before quantitation of viability. After 2 days, all of the dauer larvae, including the DMSO controls, were relatively motionless and appeared as rigid rods. To activate the worms, 1 μl of 1 N sodium hydroxide was added to each well and the plates were agitated vigorously before counting. This was done one well at a time. Worms that failed to move and remained as rigid rods after sodium hydroxide treatment and agitation were considered dead.

The dose-response experiments for the anthelmintic/nematicide-resistant mutants were carried out as described for the L1 dose-response assays. One notable exception is the aldicarb-resistant strain PR1152. This strain grows slowly, and so the viability counts were performed 5 days after addition of the chemical, as opposed to 3 days, to allow the DMSO control worms to reach adulthood.

At least three biological replicates were performed for each dose-response assay. For each biological replicate, two technical replicates were performed and the numbers of viable animals for each technical replicate were combined (i.e. ˜50 worms assayed per concentration). The number of viable worms at each concentration was divided by the corresponding DMSO control value to give the “relative viability” for each concentration. The “relative viability” values were then averaged across the biological replicates. LC₅₀ values were calculated using Graphpad Prism. The concentration values were log-transformed and a four-parameter logistic curve was fitted to the dose-response data by non-linear regression, from which the LC₅₀ values were extracted.

### Example 4: Pristionchus pacificus Dose-Response Experiments

Dose-response assays were carried out exactly as those described above for the C. elegans L1 dose-response experiments. However, the compounds of the application-induced phenotypes in P. pacificus, even at the highest concentrations, were a combination of lethality and larval arrest. Therefore, for the Pristionchus dose-response assays, the number of animals that reached the L3 stage or older was quantified, as opposed to the number of viable worms. The arrested animals appeared very sick, and would likely die before reaching reproductive adulthood. Therefore, this arrested phenotype was considered to be practically analogous to lethality. The “relative viability” values were calculated the same way as for the C. elegans dose-response experiments, and were averaged across at least three biological replicates. LC₅₀ values were calculated in the same manner as for the C. elegans dose-response assays.

### Example 5: Cooperia oncophora Dose-Response Experiments

Fresh cattle faeces containing eggs of an ivermectin-resistant strain of C. oncophora were kindly supplied by Dr. Doug Colwell and Dawn Gray (Lethbridge Research Station, Agriculture and Agri-Food Canada). Established methods were used to carry out the experimental cattle infections⁶⁰, and these methods were approved by the Lethbridge AAFC Animal Care committee and conducted under animal use license ACC1407. Cattle faeces containing C. oncophora eggs were stored anaerobically at room temperature for a maximum of 6 days before use. Eggs were isolated from faeces using a standard saturated salt flotation method⁶¹ immediately before the egg hatch assay. 80 μl of distilled and deionized water was added to each well of a 96-well culture plate, and then 1 μl of chemical at the appropriate concentration in DMSO was added to each well using a multichannel pipette. Approximately 50 eggs were added per well in 20 μl of water for a final volume of 100 μl in each well, the final DMSO concentration was 1% (v/v). The eggs were incubated in the chemicals for 2 days at room temperature, after which hatching was stopped by the addition of 1 μl iodine tincture to each well. The number of hatched larvae was counted at each concentration, and eggs that failed to hatch were scored as dead. “Relative viability” values were calculated by dividing the fraction of eggs that hatched at each concentration by the fraction of eggs that hatched in the corresponding DMSO control wells. Two biological replicates were performed for each dose-response experiment, and the relative viability values were averaged across the biological replicates. The average hatch rate for the DMSO control wells was greater than 93% for both biological replicates. LC₅₀ values were calculated in the same manner as for the C. elegans dose-response assays

### Example 6: Saccharomyces cerevisiae (Budding Yeast) Dose-Response Experiments

A saturated culture of the yeast strain RY0568 was diluted to an OD600 of 0.015 with fresh YPD media (see ref. 62). 100 μL of this dilute yeast suspension was added to each well of a 96-well plate. The yeast were grown for 4 hours at 30° C. with shaking at 140 rpm. Using a multichannel pipette, 1 μL of chemical solution was added to each well to achieve the desired final concentrations. The final DMSO concentration was 1% (v/v). The microwell plate was then loaded into a TECAN plate reader set at 30° C. The OD600 of each well was measured over an 18-hour period, and the plate was shaken intermittently throughout the run. The areas under the resultant growth curves were calculated using R scripts adapted from those found in the MESS package. The area under the curve at each concentration of a dose-response assay was divided by the area under the curve for the corresponding DMSO control, resulting in a “relative fitness” value for each concentration tested. Three biological replicates were performed for each dose-response experiment, and the relative fitness values were averaged across the three replicates.

### Example 7: Danio rerio (Zebrafish) Culture and Dose-Response Experiments

Zebrafish chemical assays were performed similarly to previously described methods⁶³. In brief, fish were maintained at 28.5° C. on a 14/10 hour light/dark cycle and staged according to hours post fertilization (hpf). For each biological replicate, eggs from LT fish (AB/Tubingen strain) were collected at 4 hpf. At 24 hpf, embryos were arrayed in 24 well plates, 10 per well. In 2 ml tubes, 4 μl of chemical dissolved in DMSO at the appropriate concentration was added to 800 μl of water and then vortexed for 30 s intensively. Water was removed from the embryos in the wells and 800 μl of chemical-treated water was transferred to each of the wells. The DMSO control wells contained DMSO alone. The final DMSO concentration in every well was 0.5% (v/v). Some compound precipitation was observed for exemplary compounds Ia and Id at 100 μM. The embryos were incubated in the chemicals for 24 hours and scored for death and toxicity at 48 hpf. Toxicity was defined as the embryos showing developmental defects such as a curved body, reduced body size, skin whiteness, and heart edema. “Relative viability” was calculated by dividing the number of viable and properly developed embryos in the treatment wells by the average number of viable and properly developed embryos across six DMSO control wells. Three biological replicates were performed for each dose-response experiment, and the relative viability values were averaged across the three replicates.

### Example 8: HEK Cell Culture and Dose-Response Experiments

HEK293 cells were seeded into 96-well plates, at 5000 cells per well, in 100 μL total volumes of DMEM/10% FBS/1% PS media and grown overnight at 37° C. in the presence of 5% CO₂. Compounds (0.5 μL volumes from appropriate source plates) were then added to cells, and growth was continued for an additional 48 hours. Following growth, 10 μL of CellTiter-Blue Viability reagent (Promega) was added to each well, and plates were incubated for an additional 4 hours at 37° C. in the presence of 5% CO₂. Fluorescence measurements (560 nm excitation/590 nm emission) were then performed using a CLARIOstar Plate Reader (BMG Labtech) to quantify reagent reduction and estimate cell viability.

### Example 9: Mouse Studies

Female C57BL/6 mice (bred in house, breeding pairs originally purchased from Charles River, Canada) 6-8 weeks of age were used for all experiments. Animal experiments were approved by the University of Calgary's Animal Care Committee. Infected mice were orally gavaged with a 200 third stage Heligmosomoides polygyrus larvae (maintained in house. Original stock was a gift from Dr. Allen Shostak, University of Alberta, Canada) and euthanized on day 22 post infection. Each group (treated vs. non-treated) had a minimum of 7 mice (housed in separate nearby cages to avoid infection of naïve animals); mice were littermates. Mice were treated orally with 5 daily doses of exemplary compound Ia (50 mg/kg resuspended in DMSO). Control mice were given DMSO only as a control.

### Example 10: Meloidogyne incognita Dose-Response Experiments

M. incognita (Kofoid & White) Chitwood Race 1 (originally isolated in Maryland) was used for all experiments, and were maintained on pepper (Capsicum annuum L.) cv. PA-136 in a greenhouse as previously described⁶⁴. Infective J2 juveniles were collected as described in ref. 65. The microwell dose-response experiments were carried out similarly to previously described protocols^{64, 66}. In brief, 100 J2 s, in 10 μL of deionized water, were added to the wells of 96-well polystyrene plates, after which 190 μL of deionized water containing dissolved chemical, or DMSO alone, was added to each well. The final concentration of DMSO in each well was 0.5% (v/v), except for the water only control which contained no DMSO and no added chemicals. The final concentrations of the chemicals for each dose-response experiment were 5, 15, and 45 μM. The wells were covered with a plastic adhesive strip, and the lids of the plates were sealed with parafilm. The plates were incubated at 25° C. The fraction of active worms was quantified by counting the number of mobile and immobile worms after 1 and 2 days of incubation, and then dividing the number of mobile worms by the total number of worms in the well. After 2 days of incubation, the chemicals were removed and replaced with deionized water (i.e. the water rinse) and the fraction of active worms was quantified 1 day later. A failure of the worms to recover after rinsing with water is consistent with them having been killed by the chemical treatment. Four technical replicates were performed for each treatment.

### Example 11: Forward Genetic Screens for C. elegans Resistant Mutants

Forward genetic screens were carried out as previously described⁴⁸. Briefly, wild-type parental (PO) worms were mutagenized in 50 mM ethyl methanesulfonate (EMS) for 4 hours. Synchronized first-larval-stage worms from either the F1 (progeny) or F2 (grand-progeny) generations were dispensed onto 10 cm MYOB agar plates (see Ref. 59 for how to prepare MYOB/agar media) containing a 100% penetrant lethal dose of the nematicide. Worms were plated at a density of 20,000 L1s per plate.

### Example 12: Haemonchus contortus Egg Hatching Assay

Fresh sheep faeces containing eggs of the MHco3(ISE) strain of H. contortus was supplied by Dr. Doug Colwell and Dawn Gray (Lethbridge Research Station, Agriculture and Agri-Food Canada). Experimental infections used to generate this material were carried out using established methods⁷², and were approved by the Lethbridge AAFC Animal Care committee and conducted under animal use license ACC1407. Sheep faeces containing H. contortus eggs were stored at 20° C. for no longer than 48 h before harvesting eggs for use. Eggs were isolated from faeces using a standard saturated salt flotation method⁶¹ immediately before each egg hatch assay. Approximately 100 eggs suspended in 100 μl of water were added to each well of a 96-well plate, and the exemplary compounds of the application were tested at 60 μM, 0.6% DMSO (v/v). Egg hatch rates were determined 48 hours after the initial set-up of the assay by the addition of iodine tincture to stop development. Example 13: Arabidopsis thaliana greening experiments

Greening experiments were performed with Arabidopsis thaliana seeds of wild type Col-0; seeds were surface sterilized in bleach and plated onto 0.5×MS, 0.5% sucrose agar medium supplemented with compounds of interest at 5, 15 and 45 μM concentrations. After 4 d of stratification at 4° C., plates were transferred to a growth chamber (16 h/8 h, 150 μE/m²) and greening recorded after 4 days. Pictures were recorded by camera (SONY a7s) with FE1.8/55 lens (FE 55 mm F1.8 ZA; SEL55F18Z). Experiments were performed in triplicate for each treatment.

### Example 14: HepG2 Cell Proliferation Assay

HepG2 cells, which are liver-derived, were counted using a haemocytometer, diluted, and seeded in 384-well plates to a final density of 5×10⁴ cells/mL in 100 uL of RPMI-1640 medium supplemented with 10% heat inactivated fetal bovine serum (Gibco) and 1.2×Antibiotic-Antimycotic (Gibco). Cells were incubated at 37° C. with 5% CO₂ for 24 hours. Subsequently, a 2-fold dilution series of test compound was added to cells at a final volume of 200 uL and incubated at 37° C. with 5% CO₂ for 72 hours. After 72 hours, Alamar Blue (Invitrogen) was added to the Hep G2 cells at a final concentration of 0.5× and plates were incubated at 37° C. for 4 hours. Fluorescence was measured at Ex560 nm/Em590 nm and corrected for background from the medium. All assays were performed in technical triplicates and in at least two biological replicates. The IC₅₀ value was defined as the concentration that inhibits cell proliferation by 50% of the untreated control cells.

### Example 15: Meloidogyne incognita In Vitro Assays

M. incognita (Kofoid & White) Chitwood Race 1 (originally isolated in Maryland) was used for all experiments, and was maintained on pepper (Capsicum annuum L.) cv. PA-136 in a greenhouse as previously described⁶⁴. Infective J2 juveniles were collected as described in ref.65. The microwell dose-response experiments were carried out similarly to previously described protocols^{64, 66}. In brief, 100 J2s, in 10 μL of deionized water, were added to the wells of 96-well polystyrene plates, after which 190 μL of deionized water containing dissolved chemical, or DMSO alone, was added to each well. The chemicals were tested at 45 μM, and the final concentration of DMSO in each well was 0.5% (v/v). The wells were covered with a plastic adhesive strip, and the lids of the plates were sealed with parafilm. The plates were incubated at 25° C. The mobile fraction of worms was quantified by counting the number of mobile and immobile worms after 2 days of incubation, and then dividing the number of mobile worms by the total number of worms in the well. Three technical replicates were performed for each treatment, and an average value for the mobile fraction of worms was calculated across the three replicates. The percent effectiveness at inhibiting nematode movement was calculated by dividing the average value for the chemical treatment by the average value for the DMSO control, then subtracting this value from 1, and then multiplying by 100.

### Example 16: Meloidogyne chitwoodi In Vitro Assays

M. chitwoodi race 1 (the strain commonly found in the pacific northwest of the United States) was used for all experiments, and was maintained on tomato plants (Solanum lycopersicum ‘Rutgers’) as previously described⁷³. The M. chitwoodi in vitro assays were performed identically to the M. incognita in vitro assays (see above).

### Example 17: Meloidogyne incognita Infectivity Assays

An M. incognita population originally collected from grape (Vitis vinifera) in Parlier, Calif., was used for all experiments, and they were maintained on tomato plants (Solanum lycopersicum ‘Rutgers’) as previously described⁷³. Infective J2 juveniles were collected as described in⁷³. For the infectivity assays, 90 grams of soil (1:1 sand:loam mix) was added to each cell of several 6-cell plastic garden packs. The soil was drenched with 18 mL of deionized water containing dissolved chemical or DMSO alone. 2,500 infective J2 juveniles were then added to the soil in 2 mL of deionized water, for a total water volume of 20 mL. The final concentration of the chemicals in water was 45 μM. The DMSO concentration varied from 0.1% to 0.8% (v/v) depending on the stock concentration of the chemical. The highest DMSO concentration was used as the DMSO control. The J2s were incubated in the soil and chemical for 24 hours, after which two- to three-week old tomato seedlings were transplanted into the soil (one plant per cell). Two replicates were performed for each chemical treatment, and four replicates were done for the DMSO controls. The whole experiment was replicated twice, in two different batches on two different days, for a total of four replicates for each chemical treatment, and eight replicates for the DMSO controls. Inoculated plants were grown for 8 weeks in a greenhouse, as described⁷³, under long-day conditions (16-h photoperiod) with 26/18° C. day/night temperatures. After 8 weeks, the plants were destructively harvested. The tops were removed and discarded, and roots were gently washed with water to remove adhering soil. Eggs were extracted by placing rinsed roots in 0.6% sodium hypochlorite and agitating at 300 rpm for 3 min. Roots were then rinsed over nested 250- and 25.4-μm sieves, with eggs collected from the latter and suspended in water. Roots were dried in a 65° C. oven for at least 24 hours, after which dry roots were weighed. The number of eggs from each plant root was counted on a dissection microscope using a haemocytometer, and the number of eggs per milligram of root was calculated by dividing the total egg number by the mass of the dried root material. An average was taken across the replicates performed on the same day, and then normalized to the DMSO control average. To calculate percent effectiveness at inhibiting reproduction, the normalized values were subtracted from 1, and then multiplied by 100. An average percent effectiveness value was then calculated across the two different batches carried out on different days.

### Example 18: Meloidogyne chitwoodi Infectivity Assays

M. chitwoodi race 1 (the strain commonly found in the pacific northwest of the United States) was used for all experiments, and was maintained on tomato plants (Solanum lycopersicum ‘Rutgers’) as previously described⁷³. The M. chitwoodi infectivity assays were performed identically to the M. incognita infectivity assays (see above), with the exception that egg counts were not normalized to the mass of the roots. Four technical replicates were performed in a single batch. An average was taken across the four replicates performed on the same day, and then normalized to the DMSO control average. To calculate percent effectiveness at inhibiting reproduction, the normalized values were subtracted from 1, and then multiplied by 100.

### Results

### Imidazothiazole Compounds of the Application Kill Nematodes Selectively

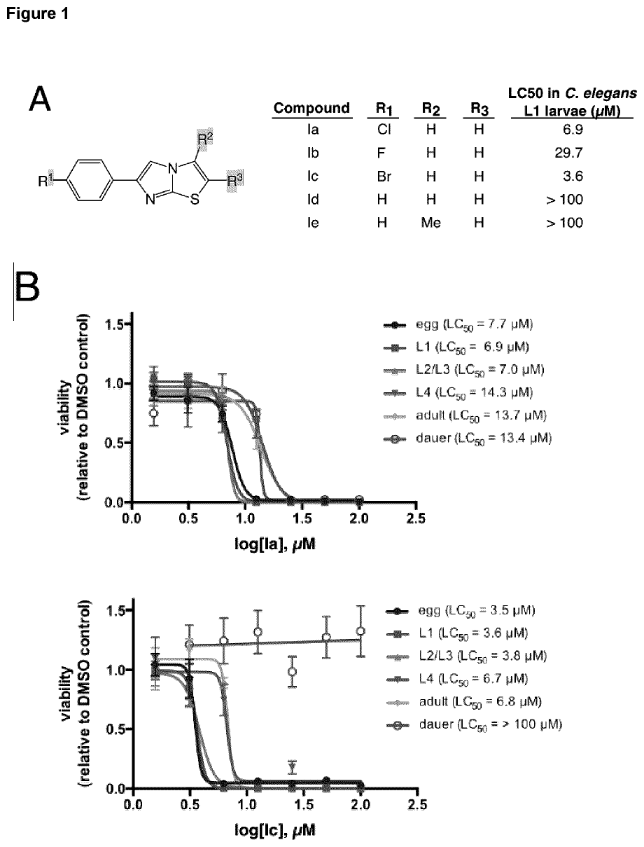

Close to 100,000 small organic molecules were screened for those that kill the free-living nematode Caenorhabditis elegans. C. elegans was used as a primary screening system due to its small size and ease-of-culture, which makes it amenable to high-throughput chemical screens, and because the majority of commercial nematicides and anthelmintics are effective against C. elegans⁴²⁻⁴⁸. One class of nematicides that was identified from the screens contained the imidazo[2,1-b]thiazole ring system (FIG. 1A) of the compounds of the application. Dose-response assays with the two most potent exemplary compounds of the application, Ia and Ic, demonstrated that they can kill each developmental stage of C. elegans from embryo to adult with micromolar potency (FIG. 1B). In addition, exemplary compound Ia can also kill the non-reproductive dauer stage of C. elegans (FIG. 1B), which is in many ways analogous to the infective larvae of parasitic nematodes⁴⁹. These results suggest that the compounds of the application can be relatively potent nematicides, and that the mechanism by which they kill nematodes is not limited to any one developmental stage.

C. elegans-based chemical screens will inevitably identify several nematicides that are active against C. elegans specifically and are ineffective against distinct nematode species⁴⁸. To assess whether the compounds of the application have activity in other nematodes aside from C. elegans dose-response assays were performed with larvae of the free-living nematode Pristionchus pacificus, and with embryos of the parasitic nematode Cooperia oncophora, which is a parasite of cattle²⁴. All six of the exemplary compounds of the application tested had activity in both of these nematode species, with the most potent analogs killing nematodes in the low micromolar range (Table 1). To further test the activity of the exemplary compounds against parasitic nematode species, the hatch rate of eggs isolated from the parasitic nematode Haemonchus contortus was measured after a 48-hour treatment with 60 micromolar of the exemplary compounds Ia and Ib. Exemplary compound Ib completely inhibited egg hatching, and exemplary compound Ia reduced egg hatching by 99 percent, relative to the untreated mock control (Table 2). These data are consistent with the compounds of the application having broad nematicidal activity across diverse nematode species, and suggest that the compounds of the application can be effective against both free-living and parasitic nematodes.

TABLE 1
LC₅₀ values of the exemplary compounds of the application in nematodes and non-target systems

| | nematode species | | | non-target systems | | |
|---|---|---|---|---|---|---|
| | C. elegans | P. pacificus | C. oncophora | S. cerevisiae | HEK Cells | D. rerio |
| compound | LC₅₀ (μM) | LC₅₀ (μM) | LC₅₀ (μM) | LC₅₀ (μM) | LC₅₀ (μM) | LC₅₀ (μM) |
| Ia | 6.9 | 6.1 | 3.7 | >100 | >100 | >100 |
| Ib | 29.7 | 14.7 | 5.4 | >100 | >100 | >100 |
| Ic | 3.6 | 3.0 | 3.5 | >100 | >100 | >100 |
| Id | >100 | 45.2 | 2.3 | >100 | >100 | >100 |
| Ie | >100 | 45.5 | 0.9 | >100 | >100 | >100 |

^{a} A four-parameter logistic curve was fitted to the dose-response data by non-linear regression, and the minimum (or bottom) of the curve was constrained to be equal to zero. The LC₅₀ value estimated from this analysis is what is reported in the table.

TABLE 2
Effect of the exemplary compounds of the application treatment on the
hatching of Haemonchus contortus eggs

| | Concentration | Hatch Rate | Number of |
|---|---|---|---|
| Treatment | (μM) | (%)^{a} | Replicates |
| Mock | — | 82.0 ± 8.6 | 6 |
| Ia | 60 | 1.0 ± 1.7 | 3 |
| Ib | 60 | 0.0 ± 0.0 | 3 |

^{a}Hatch rates are shown plus or minus the standard deviation of the mean

To assess the specificity of the compounds of the application for nematodes dose-response assays were performed in three non-target systems selected from distinct phyla: 1. The budding yeast Saccharomyces cerevisiae, 2. Embryos of the zebrafish Danio rerio, and 3. Human embryonic kidney (HEK) cells in culture. All of the exemplary compounds of the application tested were relatively inactive against yeast and HEK cells up to a concentration of 100 micromolar, which is their limit of solubility, suggesting that the compounds of the application are not generally cytotoxic (Table 1). The majority of the exemplary compounds of the application had no effect on zebrafish viability up to a concentration of 100 micromolar (Table 1). Regardless, the exemplary compounds Ia and Ic, which were the most active across the three nematode species tested, were inactive against all three non-target systems. Furthermore, mice given an oral dose of exemplary compound Ia at 50 mg/kg over several days did not exhibit any obvious pathologies in comparison with the solvent control. Taken together, these data suggest that the compounds of the application can kill nematodes with a high degree of specificity.

Exemplary Compound La Kills the Plant-Parasitic Nematode M. incognita More Potently than a Commercial Nematicide

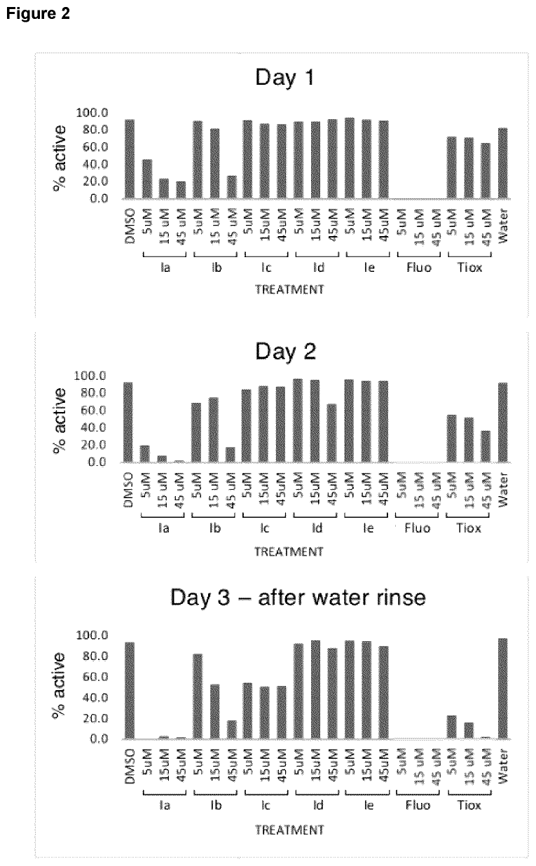

Root-knot nematodes (Meloidogyne spp.) are considered to be the most economically important nematode parasites of plants¹⁴. In particular, the Southern root-knot nematode, Meloigogyne incognita, is arguably the most damaging crop parasite, since it is able to infect the roots of virtually all cultivated plants^{12, 14, 41}. The ability of exemplary compounds of the application to kill M. incognita infective juveniles was tested at 5, 15, and 45 micromolar concentrations in an in vitro dose-response assay (FIG. 2). The commercial nematicides fluopyram and tioxazafen were used as positive controls for the experiment. The percent of worms that were active was quantified at each concentration after 1 and 2 days of chronic exposure, after which the animals were rinsed with water to remove the chemicals and allowed to recover for an additional 24 hours before quantifying worm activity on the third day. A failure of the worms to recover after rinsing with water is consistent with them having been killed by the chemical treatment. Exemplary compounds Ia, Ib, and Ic all demonstrated nematicidal activity at one or more concentrations by the third day (FIG. 2). The commercial nematicide fluopyram was the most potent compound tested. However, exemplary compound Ia outperformed the commercial nematicide tioxazafen, showing greater inhibitory effects on worm activity at each time point and at every concentration tested (FIG. 2). Exemplary compound Ia treatment resulted in 100% nematode lethality at the lowest concentration assayed. These results suggest that the compounds of the application have strong potential as nematicides for crop protection.

Activity of Exemplary Compounds of the Application Against C. elegans and M. Chitwoodi

The ability of exemplary compounds of the application to kill C. elegans at 100 μM (except for compound If which was tested at 50 μM) and to affect the mobility of M. chitwoodi at 45 μM was tested as described above for M. incognita infective juveniles. Percent mobility was measured after 2 days of chronic exposure to test compounds (Table 3).

TABLE 3
Effect of the exemplary compounds of the application on C. elegans
viability and root-knot nematode (RKN) M. chitwoodi mobility.

| | | | | C. elegans | RKN mobility |
|---|---|---|---|---|---|
| Compound | R¹ | R² | R³ | viability (%) | (%) |
| DMSO | — | — | — | 100 | 87.4 |
| control- | | | | | |
| Ia | CI | H | H | 0 | 0 |
| Ib | F | H | H | 0 | 43.2 |
| Ic | Br | H | H | 0 | 66.6 |
| Id | H | H | H | 100 | 69.7 |
| Ie | H | Me | H | 100 | 50.8 |
| If | CI | Me | H | 19.8 | 0.6 |
| Ig | CI | H | Me | 100 | 82.4 |
| Ih | I | H | Me | 95.4 | 82.5 |
| Ii | F | H | Me | 100 | 28.9 |

The Compounds of the Application have a Mechanism-of-Action that is Distinct from Commercial Anthelmintics and Nematicides

The commercial anthelmintic levamisole belongs to a class of alicyclic imidazothiazole compounds⁵⁰. Levamisole is the levorotatory isomer of the racemic mixture tetramisole, and it acts by agonizing nicotinic acetylcholine receptors in the body wall muscles of worms resulting in paralysis and eventual death⁵¹⁻⁵³. Whether or not the compounds of the application have a similar mode-of-action to levamisole was investigated. Dose-response assays with exemplary compounds of the application were performed with the levamisole-resistant mutants unc-29(e1072) and unc-63(ok1075), each of which are homozygous for a loss-of-function allele of a nicotinic acetylcholine receptor subunit gene that confers complete resistance to levamisole^{52, 54, 55}. It was shown that both mutants are sensitive to the exemplary compounds of the application, with LC₅₀ values comparable to those of wild-type worms (Table 4), suggesting that the compounds of the application kill nematodes by a mechanism distinct from that of levamisole. Studies have shown that, in addition to levamisole, unc-29 and unc-63 mutants are also resistant to the aminophenylamidine and tetrahydropyrimidine classes of anthelmintics⁵³ suggesting that these compounds, like levamisole, act by a different mechanism than the compounds of the application.

To further explore the mode-of-action of the compounds of the application the dose-response of seven additional anthelmintic- or nematicide-resistant mutants with the compounds of the application (Table 4) was tested. The seven mutant strains are each resistant to a distinct class of anthelmintic/nematicide, namely the macrocyclic lactones (e.g. ivermectin)⁴⁴, the benzimidazoles (e.g. albendazole)⁴³, the aminoacetonitrile derivatives (e.g. monepantel)⁴⁶, the cyclo-octadepsipeptides (e.g. emodepside)⁴⁵, the flavonoids (e.g. apigenin)⁴⁷, the organophosphate/carbamate acetylcholinesterase inhibitors (e.g. aldicarb)⁴², and fluopyram⁴⁸. The macrocyclic lactones and the benzimidazoles are widely used anthelmintics to treat humans and animals infected with parasitic nematodes, and the acetylcholinesterase inhibitors are a class of pesticides that have been in common use to protect crops from both insect and nematode pests. Fluopyram is a newly marketed seed treatment to combat both fungal and nematode infections of plants. The dose-response analyses showed that all seven resistant mutants are as sensitive as wild-type worms to the exemplary compounds of the application (Table 4), providing further evidence that the compounds of the application have a unique mechanism-of-action compared with commercial compounds.

TABLE 4
Micromolar LC₅₀ values of the exemplary compounds in wild-type
C. elegans and anthelmintic/nematicide-resistant mutants

| Strain | | | | | |
|---|---|---|---|---|---|
| Name | Genotype | Resistance | Ia | Ib | Ic |
| N2 | wild-type | none | 6.9 | 29.7 | 3.6 |
| VC731 | unc-63(ok1075) | LEV¹, APAs², THPs³ | 6.4 | 28.5 | 3.1 |
| CB1072 | unc-29(e1072) | LEV¹, APAs², THPs³ | 5.7 | 24.3 | 1.6 |
| DA1316 | avr-14(ad1305); | MLs⁴ | 4.6 | 14.5 | 3.0 |
| | avr-15(vu227); | | | | |
| | glc-1(pk54) | | | | |
| CB3474 | ben-1(e1880) | BZs⁵ | 6.4 | 17.0 | 3.1 |
| RB2119 | acr-23(ok2804) | AADs⁶ | 6.9 | 27.5 | 3.3 |
| NM1968 | slo-1(js379) | Emodepside | 4.4 | 16.0 | 3.1 |
| CF1038 | daf-16(mu86) | Apigenin | 5.7 | 16.0 | 3.1 |
| PR1152 | cha-1(p1152) | AChE inhibitors⁷ | 3.7 | 14.9 | 2.3 |
| RP2674 | mev-1(tr393) | Fluopyram | 4.9 | 16.4 | 1.6 |

¹LEV = levamisole
²APA = aminophenylamidine
³THP = tetrahydropyrimidine
⁴ML = macrocyclic lactone
⁵BZ = benzimidazole
⁶AAD = aminoacetonitrile derivative
⁷AChE = acetylcholinesterase
Nematode resistance to the compounds of the application is difficult to achieve

The emerging resistance of parasitic nematodes to all of the major anthelmintic drug classes is a significant challenge to the sustainable management of parasitic nematode infections in the agriculture sector⁵⁶. In the lab, through the use of chemical mutagens such as ethyl methanesulfonate (EMS), it is relatively easy to generate C. elegans mutants that are resistant to the major classes of anthelmintics^{46, 57}, suggesting that the evolution of resistance in the lab may foreshadow the development of resistance in the field. To determine the ease by which compounds of the application-resistant mutants can be generated, C. elegans parental worms were randomly mutagenized with EMS and screened for animals in the first (F1) and second (F2) generations that resist the lethality induced by exemplary compound Ia. Despite screening through 10 million F1 genomes, and 100,000 F2 genomes, a single exemplary compound Ia resistant mutant (Table 5) was not found. Consistent with these data, a second screen of 150,000 F1 genomes, and 50,000 F2 genomes, failed to identify mutants resistant to exemplary compound Id (Table 5). In contrast, previous studies have shown that mutants resistant to commercial anthelmintics and nematicides such as levamisole, albendazole, ivermectin, and the aminoacetonitrile derivatives can be found at a frequency of one in every several thousand mutant genomes (Table 5)^{42, 46, 57}. These results suggest that nematode resistance to the compounds of the application is relatively difficult to achieve.

TABLE 5
Results of genetic screens for C. elegans mutants resistant to
exemplary compounds of the application and major anthelmintics

| | # of | # of | | |
|---|---|---|---|---|
| | mutagenized | mutagenized | # of resistant | |
| nematicide/ | F1 genomes | F2 genomes | mutants | |
| anthelmintic | screened | screened | identified | Reference |
| Ia | 10,000,000 | 100,000 | 0 | This work |
| Ic | 150,000 | 50,000 | 0 | This work |
| Levamisole | 0 | 10,000 | 31 | Ref. 57 |
| Albendazole | 0 | 10,000 | 22 | Ref. 57 |
| Ivermectin | 0 | 10,000 | 8 | Ref. 57 |
| AADs¹ | 0 | 1,000,000 | 43 | Ref. 52 |

¹The aminoacetonitrile derivatives

Effects of the Exemplary Compounds of the Application on the Greening of Arabidopsis thaliana Plants as they Grow Under Light.

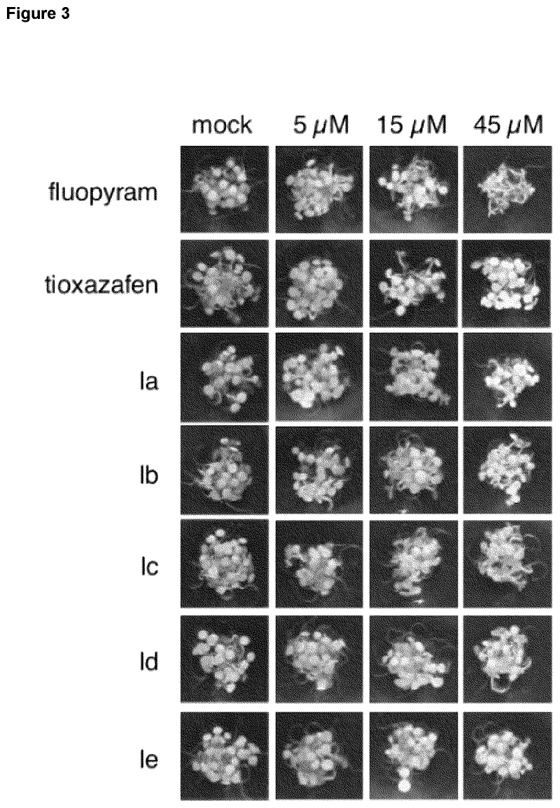

To assess potential plant toxicity, the effects of the exemplary compounds of the application, and the two commercial nematicides Tioxazafen and Fluopyram, on the greening of Arabidopsis thaliana plants as they grow under light was tested. The exemplary compounds of the application were tested at 5, 15, and 45 micromolar concentrations. As can be seen in FIG. 3, the exemplary compounds of the application had no effect on the health and greening of the plants. However, it is noted that exemplary compound Ia caused some phytotoxicity and yellowing at the highest concentration, but not at the two lower concentrations. Both of the commercial nematicides were phytotoxic at 15 and 45 micromolar. This shows that the compounds of the application are not generally phytotoxic, and that they perform comparably to, if not better than, the commercial nematicides.

Compounds of the Application Demonstrate Nematicidal Activity Against the Free-Living Nematode Caenorhabditis elegans

Compounds Ia to Im, dose-response assays were performed with C. elegans. 8 of the compounds killed C. elegans with minimum lethal concentrations less than or equal to 100 μM (Table 6). Compounds Ia, Ic, and Ij were the most potently lethal nematicides in this assay, having minimum lethal concentrations of 6.25 μM and below. The positive control nematicide tioxazafen killed nematodes at 3.13 μM and above.

TABLE 6
Effects of compounds of formula I on the viability of C. elegans.

| Compound | Minimum Lethal | Minimum Lethal |
|---|---|---|
| Name | Concentration (μM) | Concentration (ppm) |
| Ia | 6.25 | 1.5 |
| Ib | 25 | 5.5 |
| Ic | 6.25 | 1.7 |
| Id | >100 | >20.0 |
| Ie | >100 | >21.4 |
| If | 25 | 6.2 |
| Ig | >100 | >24.9 |
| Ih | >100 | >34.0 |
| Ii | >100 | >23.2 |
| Ij | 1.56 | 0.5 |
| Ik | 50 | 11.6 |
| Il | 25 | 7.3 |
| Im | >100 | >29.3 |
| tioxazafen | 3.13 | 0.7 |

Compounds of the application inhibit the movement of infective larvae from the plant-parasitic root-knot nematode species Meloidgyne incognita and Meloidogyne chitwoodi in vitro

Encouraged by their nematicidal activity against C. elegans, the activity of compounds of the application was assayed against PPNs. To that end, in vitro experiments were performed to test the effects of compounds Ia to Ij on the movement of infective J2 larvae from the plant-parasitic root-knot nematode species M. incognita and M. chitwoodi. The infective J2 larvae were treated with 45 μM (˜10 ppm) of the compounds for 2 days, and the percent effectiveness at reducing nematode movement, relative to the DMSO control, was calculated for each compound. 6 compounds reduced M. incognita J2 movement to a level below that of the untreated nematodes (Table 7), and compounds Ia and Ib reduced M. incognita J2 movement to a level below that of the positive control nematicide tioxazafen (Table 7). All of the compounds reduced M. chitwoodi J2 movement to a level below that of the untreated nematodes (Table 7), and compounds Ia, If, Ii, and Ij reduced M. chitwoodi J2 movement to a level below that of the positive control nematicide tioxazafen (Table 7). These results demonstrate that compounds of formula I can be effective at inhibiting the movement of PPNs at low parts per million values.

TABLE 7
Effects of compounds of formula I on the movement of root-knot
nematode J2 larvae in vitro.

| | | | % | % |
|---|---|---|---|---|
| | | | effectiveness | effectiveness |
| Com- | | | at reducing | at reducing |
| pound | Concentration | Concentration | M. incognita | M. chitwoodi |
| Name | (μM) | (ppm) | movement | movement |
| Ia | 45 | 10.6 | 65.3 | 64.5 |
| Ib | 45 | 9.8 | 66.9 | 37.5 |
| Ic | 45 | 12.6 | 4.5 | 22.1 |
| Id | 45 | 9.0 | 17.7 | 24.3 |
| Ie | 45 | 9.6 | 4.9 | 24.3 |
| If | 45 | 11.2 | 3.5 | 99.3 |
| Ig | 45 | 11.2 | 0.0 | 5.7 |
| Ih | 45 | 15.3 | 0.0 | 5.6 |
| Ii | 45 | 10.5 | 0.0 | 66.9 |
| Ij | 45 | 14.7 | 0.0 | 41.8 |
| tioxazafen | 45 | 10.3 | 55.5 | 40.0 |

Compounds of Formula I can Inhibit the Infection of Tomato Plant Roots by the Plant-Parasitic Nematodes Meloidogyne incognita and Meloidogyne chitwoodi

The inhibition of movement observed with compounds of formula I in the in vitro assay is promising, however it is not uncommon for compounds that are active in vitro to lose activity in soil-based experiments. The loss of activity that occurs when transitioning from in vitro assays to soil-based experiments could be a result of the compounds adsorbing onto the various components of the soil mixture, thereby reducing their aqueous concentration. The converse is also true, compounds that do not obviously inhibit the movement of nematodes in vitro can sometimes prevent root infection in soil-based experiments. Commercially useful nematicides desirably prevent the infection of plant roots in the soil. Thus, to assess their “real-world” potential, 9 compounds of formula I were tested for their ability to prevent root infection of tomato plants in soil (Table 8). 7 of the 9 compounds were tested against M. incognita, and 3 out of 9 compounds were tested against M. chitwoodi (Table 8). Before planting, the test compounds were diluted in water and then added to the soil, after which infective J2 larvae were added to the soil in water. The final concentration for all of the compounds was 45 μM (˜10 ppm). The nematodes were incubated in the test compounds in soil for 24 hours, after which tomato seedlings were planted. The nematodes were given 8 weeks to infect the roots and produce eggs, afterwhich the number of eggs per unit mass of roots was calculated. The percent effectiveness at inhibiting nematode reproduction in the roots, relative to the DMSO control, was then calculated for each compound. This value is used as a proxy to assess the infectivity of the nematodes. All 7 of the compounds tested against M. incognita reduced nematode reproduction in the roots to a level below that of the untreated samples (Table 8). Compound Ig has a percent effectiveness (44.2%) greater than that of the commercial nematicide tioxazafen (43.7%), used here as a positive control. The three compounds tested against M. chitwoodiwere 35.4%, 42.6%, and 46.2% effective at inhibiting reproduction, respectively, relative to the untreated samples (Table 8). A positive control was not included alongside the M. chitwoodi experiments. These results suggest that compounds of formula I, at low parts per million concentrations, can inhibit plant root infection by parasitic nematodes in the soil, and support the real-world utility of these compounds as nematicidal agents. Furthermore, treatment of tomato plants with compounds of formula I did not reduce root weights relative to the DMSO control, suggesting that these compounds do not have obvious phytotoxic effects on root growth (Table 9).

TABLE 8
Effects of compounds of formula I on the reproduction of root-knot
nematodes in roots.

| | | | % | % |
|---|---|---|---|---|
| | | | effectiveness | effectiveness |
| | | | at inhibiting | at inhibiting |
| Com- | | | reproduction | reproduction |
| pound | Concentration | Concentration | of M. | of M. |
| Name | (μM) | (ppm) | incognita | chitwoodi |
| Ia | 45 | 10.6 | 27.1 | 42.6 |
| Ic | 45 | 12.6 | nd | 35.4 |
| If | 45 | 11.2 | nd | 46.2 |
| Ig | 45 | 11.2 | 44.2 | nd |
| Ih | 45 | 15.3 | 25.7 | nd |
| Ij | 45 | 14.7 | 12.9 | nd |
| Ik | 45 | 10.5 | 0.6 | nd |
| Il | 45 | 13.2 | 8.1 | nd |
| Im | 45 | 13.2 | 1.2 | nd |
| tioxazafen | 45 | 10.3 | 43.7 | nd |

nd = not determined

TABLE 9
Effects of compounds of formula I on the root mass of tomato plants.

| Compound | Concentration | Concentration | Normalized root mass |
|---|---|---|---|
| Name | (μM) | (ppm) | (relative to DMSO control) |
| Ia | 45 | 10.6 | 1.3 |
| If | 45 | 11.2 | 1.3 |
| Ig | 45 | 11.2 | 1.4 |
| Ih | 45 | 15.3 | 1.3 |
| Ij | 45 | 14.7 | 1.0 |
| Ik | 45 | 10.5 | 1.0 |
| Il | 45 | 13.2 | 1.4 |
| Im | 45 | 13.2 | 1.1 |
| tioxazafen | 45 | 10.3 | 1.1 |

### Compounds of the Application are Selectively Active Against PPNs

In order to replace the commercial nematicides that are being phased out due to unfavourable ecotoxicity, newly discovered nematicides desirably demonstrate selectivity for parasitic nematodes relative to non-target species such as fish and humans. In addition, recently marketed next-generation nematicides, such as fluensulfone and fluazaindolizine, are selective for PPNs over nematodes that do not parasitize plants, many of which can be beneficial to the soil^{31, 32, 74, 75}. To test the selectivity of compound Ig for PPNs its activity was assessed in human HepG2 cells and the free-living nematode C. elegans. Compound Ig was chosen for these experiments because it is the most robustly active of all of the compounds tested in the soil-based infectivity assays (Table 8). Similar to the commercial nematicide tioxazafen, compound Ig is relatively inactive against human HepG2 cells, with an IC₅₀ greater than 100 μM (˜25 ppm) (Table 10). Compound Ig is also relatively inactive against the free-living nematode C. elegans, with a minimum lethal concentration greater than 100 μM (Table 10). In comparison, tioxazafen kills C. elegans at concentrations as low as 3.13 μM (Table 10), suggesting that it is more than 32 times more potent at killing C. elegans than compound Ig. Altogether, these results suggest that compounds of formula I can be similarly effective as commercial nematicides against PPNs in soil-based infection assays, but have selectivity for parasitic nematodes that is comparable to, or better than, commercially used compounds.

TABLE 10
Bioactivity summary for compound Ig of formula I and the
commercial nematicide tioxazafen.

| | | | % effectiveness at inhibiting |
|---|---|---|---|
| Compound | HepG2 | C. elegans | reproduction of |
| Name | IC₅₀ (μM)^{a,b} | MLC (μM)^{c} | M. incognita at 45 μM |
| Ig | >100 | >100 | 44.2 |
| tioxazafen | >100 | 3.13 | 43.7 |

^{a}HepG2 cells are human cells derived from human liver.
^{b}IC₅₀ is the concentration at which HepG2 cell proliferation is inhibited to 50% of untreated control cells.
^{c}MLC is the minimum lethal concentration (see Materials and Methods for a more complete definition).

### FULL CITATIONS FOR DOCUMENTS REFERRED TO IN THE APPLICATION

(1) Alexandratos, N., and Bruinsma, J. (2012) World agriculture towards 2030/2050: the 2012 revision.
(2) Tilman, D., Balzer, C., Hill, J., and Befort, B. L. (2011) Global food demand and the sustainable intensification of agriculture. Proc. Natl. Acad. Sci. 108, 20260-20264.
(3) Foley, J. A., Ramankutty, N., Brauman, K. A., Cassidy, E. S., Gerber, J. S., Johnston, M., Mueller, N. D., Connell, C. O., Ray, D. K., West, P. C., Balzer, C., Bennett, E. M., Sheehan, J., Siebert, S., Carpenter, S. R., Hill, J., Monfreda, C., Polasky, S., Rockstro, J., Tilman, D., and Zaks, D. P. M. (2011) Solutions for a cultivated planet. Nature 478, 337-342.
(4) Godfray, H. C. J., and Garnett, T. (2014) Food security and sustainable intensification. Philos. Trans. R. Soc. B 369, 20120273.
(5) Hunter, M. C., Smith, R. G., Schipanski, M. E., Atwood, L. W., and Mortensen, D. A. (2017) Agriculture in 2050: Recalibrating Targets for Sustainable Intensification. Bioscience 67, 386-391.
(6) United Nations, Department of Economic and Social Affairs, and Population Division. (2017) World Population Prospects: The 2017 Revision, Key Findings and Advance Tables.
(7) Popp, J., Petö, K., and Nagy, J. (2013) Pesticide productivity and food security. A review. Agron. Sustain. Dev. 33, 243-255.
(8) Foley, J. A., Defries, R., Asner, G. P., Barford, C., Bonan, G., Carpenter, S. R., Chapin, F. S., Coe, M. T., Daily, G. C., Gibbs, H. K., Helkowski, J. H., Holloway, T., Howard, E. A., Kucharik, C. J., Monfreda, C., Patz, J. A., Prentice, I. C., Ramankutty, N., and Snyder, P. K. (2005) R EVIEW Global Consequences of Land Use. Science (80-.). 309, 570-574.
(9) Cunningham, S. A., Attwood, S. J., Bawa, K. S., Benton, T. G., Broadhurst, L. M., Didham, R. K., Mcintyre, S., Perfecto, I., Samways, M. J., Tscharntke, T., Vandermeer, J., Villard, M., Young, A. G., and Lindenmayer, D. B. (2013) To close the yield-gap while saving biodiversity will require multiple locally relevant strategies. Agric. Ecosyst. Environ. 173, 20-27.
(10) Oerke, E.-C. (2006) Crop losses to pests. J. Agric. Sci. 144, 31-43.
(11) Grisi, L., Leite, R. C., de Souza Martins, J. R., de Barros, A. T. M., Andreotti, R., de Leon, A. A. P., Pereira, J. B., and Villela, H. S. (2014) Reassessment of the potential economic impact of cattle parasites in Brazil. Brazilian J. Vet. Parasitol. 23, 150-156.
(12) Trudgill, D. L., and Blok, V. C. (2001) APOMICTIC, POLYPHAGOUS ROOT-KNOT NEMATODES: Exceptionally Successful and Damaging Biotrophic Root Pathogens. Annu. Rev. Phytopathol. 39, 53-77.
(13) Nicol, J. M., Turner, S. J., Coyne, D. L., den Nijs, L., Hockland, S., and Tahna Maafi, Z. (2011) Current Nematode Threats to World Agriculture, in Genomics and Molecular Genetics of Plant-Nematode Interactions (Jones, J., Gheysen, G., and Fenoll, C., Eds.), pp 21-43. Springer Science+Business Media.
(14) Jones, J. T., Haegeman, A., Danchin, E. G. J., Gaur, H. S., Helder, J., Jones, M. G. K., Kikuchi, T., Manzanilla-López, R., Palomares-Rius, J. E., Wesemael, W. M. L., and Perry, R. N. (2013) Top 10 plant-parasitic nematodes in molecular plant pathology. Mol. Plant Pathol. 14, 946-961.
(15) Bernard, G. C., Egnin, M., and Bonsi, C. (2017) The Impact of Plant-Parasitic Nematodes on Agriculture and Methods of Control, in Nematology—Concepts, Diagnosis, and Control (Shah, M. M., and Mahamood, M., Eds.), pp 121-138. InTech.
(16) Githigia, S. M., Thamsborg, S. M., Munyua, W. K., and Maingi, N. (2001) Impact of gastrointestinal helminths on production in goats in Kenya. Small Rumin. Res. 42, 21-29.
(17) Mavrot, F., Hertzberg, H., and Torgerson, P. (2015) Effect of gastro-intestinal nematode infection on sheep performance: a systematic review and meta-analysis. Parasit. Vectors 8, 1-11.
(18) Roeber, F., Jex, A. R., and Gasser, R. B. (2013) Impact of gastrointestinal parasitic nematodes of sheep, and the role of advanced molecular tools for exploring epidemiology and drug resistance—an Australian perspective. Parasit. Vectors 6, 1-13.
(19) Singh, S. K., Hodda, M., and Ash, G. J. (2013) Plant-parasitic nematodes of potential phytosanitary importance, their main hosts and reported yield losses. EPPO Bull. 43, 334-374.
(20) Sasser, J. N., and Freckman, D. W. (1987) A world perspective on nematology: the role of the society, in Vistas on nematology (Veech, J. A., and Dickson, D. W., Eds.), pp 7-14. Society of Nematology.
(21) McCarter, J. P. (2009) Molecular Approaches Toward Resistance to Plant-Parasitic Nematodes, in Cell Biology of Plant Nematode Parasitism (Berg, R. H., and Taylor, C. G., Eds.), pp 239-267. Springer-Verlag.
(22) Abd-Elgawad, M., and Askary, T. H. (2015) Impact of Phytonematodes on Agriculture Economy, in Biocontrol Agents of Phytonematodes (Askary, T. H., and Martinelli, P. R. P., Eds.), pp 3-49. CABI.
(23) Deutsch, C. A., Tewksbury, J. J., Tigchelaar, M., Battisti, D. S., Merrill, S. C., Huey, R. B., and Naylor, R. L. (2018) Increase in crop losses to insect pests in a warming climate. Science (80-.). 361, 916-919.
(24) Sutherland, I. A., and Leathwick, D. M. (2011) Anthelmintic resistance in nematode parasites of cattle: A global issue? Trends Parasitol. 27, 176-181.
(25) Sargison, N. (2011) Responsible use of anthelmintics for nematode control in sheep and cattle. In Pract. 33, 318-327.
(26) Jones, R. K. (2017) Nematode Control and Nematicides: Developments Since 1982 and Future Trends, in Nematology in South Africa: A View from the 21st Century (Fourie, H., Spaull, V., Jones, R., Daneel, M., and De Waele, D., Eds.), pp 129-150. Springer, Cham.
(27) Chitwood, D. J. (2003) Nematicides. United States Department of Agriculture —Agricultural Research Service.
(28) United Nations. (2002) Consolidated List of Products Whose Consumption and/or Sale Have Been Banned, Withdrawn, Severely Restricted or not Approved by Governments: Chemicals. Econ. Soc. Aff. New York.
(29) (2003) COUNCIL DECISION of 18 Mar. 2003 concerning the non-inclusion of aldicarb in Annex I to Council Directive 91/414/EEC and the withdrawal of authorisations for plant protection products containing this active substance. Off. J. Eur. Union.
(30) Zasada, I. A., Halbrendt, J. M., Kokalis-Burelle, N., Lamondia, J., Mckenry, M. V, and Noling, J. W. (2010) Managing Nematodes Without Methyl Bromide. Annu. Rev. Phytopathol. 48, 311-328.
(31) Lahm, G. P., Desaeger, J., Smith, B. K., Pahutski, T. F., Rivera, M. A., Meloro, T., Kucharczyk, R., Lett, R. M., Daly, A., Smith, B. T., Cordova, D., Thoden, T., and Wiles, J. A. (2017) The discovery of fluazaindolizine: A new product for the control of plant parasitic nematodes. Bioorg. Med. Chem. Lett. 27, 1572-1575.
(32) Kearn, J., Ludlow, E., Dillon, J., Connor, V. O., and Holden-Dye, L. (2014) Fluensulfone is a nematicide with a mode of action distinct from anticholinesterases and macrocyclic lactones. Pestic. Biochem. Physiol. 109, 44-57.
(33) Slomczynska, U., South, M. S., Bunkers, G. J., Edgecomb, D., Wyse-Pester, D., Selness, S., Ding, Y., Christiansen, J., Ediger, K., Miller, W., Charumilind, P., Hartmann, G., Williams, J., Dimmic, M., Shortt, B., Haakenson, W., Wideman, A., Crawford, M., Hresko, M., and Mccarter, J. (2015) Tioxazafen: A New Broad-Spectrum Seed Treatment Nematicide, in Discovery and Synthesis of Crop Protection Products (Maienfisch, P., and Stevenson, T. M., Eds.), pp 129-147. American Chemical Society.
(34) D'Errico, G., Giacometti, R., Roversi, P. F., D'Errico, F. P., and Woo, S. L. (2017) Mode of action and efficacy of iprodione against the root-knot nematode Meloidogyne incognita. Ann. Appl. Biol. 171, 506-510.
(35) Faske, T. R., and Hurd, K. (2015) Sensitivity of Meloidogyne incognita and Rotylenchulus reniformis to Fluopyram. J. Nematol. 47, 316-321.
(36) Monfort, W. S., Kirkpatrick, T. L., Long, D. L., and Rideout, S. (2006) Efficacy of a Novel Nematicidal Seed Treatment against Meloidogyne incognita on Cotton. J. Nematol. 38, 245-249.
(37) Kaplan, R. M. (2004) Drug resistance in nematodes of veterinary importance: a status report. Trends Parasitol. 20, 477-481.
(38) Bartley, D. J., Devin, L., Nath, M., and Morrison, A. A. (2015) Selection and characterisation of monepantel resistance in Teladorsagia circumcincta isolates. Int. J. Parasitol. Drugs Drug Resist. 5, 69-76.
(39) Sales, N., and Love, S. (2016) Resistance of Haemonchus sp. to monepantel and reduced efficacy of a derquantel/abamectin combination confirmed in sheep in NSW, Australia. Vet. Parasitol. 228, 193-196.
(40) Sasser, J. N. (1977) Worldwide Dissemination and Importance of the Root-knot Nematodes, Meloidogyne spp. J. Nematol. 9, 26-29.
(41) Abad, P., Gouzy, J., Aury, J. M., Castagnone-Sereno, P., Danchin, E. G. J., Deleury, E., Perfus-Barbeoch, L., Anthouard, V., Artiguenave, F., Blok, V. C., Caillaud, M. C., Coutinho, P. M., Dasilva, C., De Luca, F., Deau, F., Esquibet, M., Flutre, T., Goldstone, J. V., Hamamouch, N., Hewezi, T., Jaillon, O., Jubin, C., Leonetti, P., Magliano, M., Maier, T. R., Markov, G. V., McVeigh, P., Pesole, G., Poulain, J., Robinson-Rechavi, M., Sallet, E., Segurens, B., Steinbach, D., Tytgat, T., Ugarte, E., Van Ghelder, C., Veronico, P., Baum, T. J., Blaxter, M., Bleve-Zacheo, T., Davis, E. L., Ewbank, J. J., Favery, B., Grenier, E., Henrissat, B., Jones, J. T., Laudet, V., Maule, A. G., Quesneville, H., Rosso, M. N., Schiex, T., Smant, G., Weissenbach, J., and Wincker, P. (2008) Genome sequence of the metazoan plant-parasitic nematode Meloidogyne incognita. Nat. Biotechnol. 26, 909-915.
(42) Rand, J. B., and Russell, R. L. (1984) Choline acetyltransferase-deficient mutants of the nematode Caenorhabditis elegans. Genetics 106, 227-248.
(43) Driscoll, M., Dean, E., Reilly, E., Bergholz, E., and Chalfie, M. (1989) Genetic and Molecular Analysis of a Caenorhabditis elegans B-Tubulin That Conveys Benzimidazole Sensitivity. J. Cell Biol. 109, 2993-3003.
(44) Dent, J. A., Smith, M. M., Vassilatis, D. K., and Avery, L. (2000) The genetics of ivermectin resistance in Caenorhabditis elegans. Proc. Natl. Acad. Sci. 97, 2674-2679.
(45) Guest, M., Bull, K., Walker, R. J., Amliwala, K., O'Connor, V., Harder, A., Holden-Dye, L., and Hopper, N. A. (2007) The calcium-activated potassium channel, SLO-1, is required for the action of the novel cyclo-octadepsipeptide anthelmintic, emodepside, in Caenorhabditis elegans. Int. J. Parasitol. 37, 1577-1588.
(46) Kaminsky, R., Ducray, P., Jung, M., Clover, R., Rufener, L., Bouvier, J., Weber, S. S., Wenger, A., Wieland-berghausen, S., Goebel, T., Gauvry, N., Pautrat, F., Skripsky, T., Froelich, O., Komoin-Oka, C., Westlund, B., Sluder, A., Maser, P., and Ma, P. (2008) A new class of anthelmintics effective against drug-resistant nematodes. Nature 452, 176-180.
(47) Kawasaki, I., Jeong, M. H., Oh, B. K., and Shim, Y. H. (2010) Apigenin inhibits larval growth of Caenorhabditis elegans through DAF-16 activation. FEBS Lett. 584, 3587-3591.
(48) Burns, A. R., Luciani, G. M., Musso, G., Bagg, R., Yeo, M., Zhang, Y., Rajendran, L., Glavin, J., Hunter, R., Redman, E., Stasiuk, S., Schertzberg, M., Angus McQuibban, G., Caffrey, C. R., Cutler, S. R., Tyers, M., Giaever, G., Nislow, C., Fraser, A. G., MacRae, C. A., Gilleard, J., and Roy, P. J. (2015) Caenorhabditis elegans is a useful model for anthelmintic discovery. Nat. Commun. 6, 7485.
(49) Crook, M. (2014) The dauer hypothesis and the evolution of parasitism: 20 years on and still going strong. Int. J. Parasitol. 44, 1-8.
(50) Thienpont, D., Vanparijs, O. F. J., Raeymaekers, A. H. M., Vandenberk, J., Demoen, P. J. A., Allewijn, F. T. N., Marsboom, R. P. H., Niemegeers, C. J. E., Schellekens, K. H. L., and Janssen, P. A. J. (1966) Tetramisole (R 8299), a new, potent, broad spectrum anthelmintic. Nature 209, 1084-1086.
(51) Jones, A. K., and Sattelle, D. B. (2004) Functional genomics of the nicotinic acetylcholine receptor gene family of the nematode, Caenorhabditis elegans. BioEssays 26, 39-49.
(52) Jones, A. K., Buckingham, S. D., and Sattelle, D. B. (2005) Chemistry-to-gene screens in Caenorhabditis elegans. Nat. Rev. Drug Discov. 4, 321-330.
(53) Hu, Y., Xiao, S. H., and Aroian, R. V. (2009) The new anthelmintic tribendimidine is an L-type (Levamisole and Pyrantel) nicotinic acetylcholine receptor agonist. PLoS Negl. Trop. Dis. 3, 1-9.
(54) Fleming, J. T., Squire, M. D., Barnes, T. M., Tornoe, C., Matsuda, K., Ahnn, J., Fire, A., Sulston, J. E., Barnard, E. A., Sattelle, D. B., and Lewis, J. A. (1997) Caenorhabditis elegans Levamisole Resistance Genes lev-1, unc-29, and unc-38 Encode Functional Nicotinic Acetylcholine Receptor Subunits. J. Neurosci. 17, 5843-5857.
(55) Culetto, E., Baylis, H. A., Richmond, J. E., Jones, A. K., Fleming, J. T., Squire, M. D., Lewis, J. A., and Sattelle, D. B. (2004) The Caenorhabditis elegans unc-63 gene encodes a levamisole-sensitive nicotinic acetylcholine receptor a subunit. J. Biol. Chem. 279, 42476-42483.
(56) Sangster, N. C., Cowling, A., and Woodgate, R. G. (2018) Ten Events That Defined Anthelmintic Resistance Research. Trends Parasitol. 34, 553-563.
(57) Hu, Y., Platzer, E. G., Bellier, A., and Aroian, R. V. (2010) Discovery of a highly synergistic anthelmintic combination that shows mutual hypersusceptibility. Proc. Natl. Acad. Sci. U.S.A 107, 5955-5960.
(58) Lewis, J. A., and Fleming, J. T. (1995) Basic Culture Methods, in Caenorhabditis elegans: Modern Biological Analysis of an Organism (Epstein, H. F., and Shakes, D. C., Eds.), pp 3-29. Academic Press, Inc.
(59) Burns, A. R., Kwok, T. C. Y., Howard, A., Houston, E., Johanson, K., Chan, A., Cutler, S. R., McCourt, P., and Roy, P. J. (2006) High-throughput screening of small molecules for bioactivity and target identification in Caenorhabditis elegans. Nat. Protoc. 1, 1906-1914.
(60) Demeler, J., Kuttler, U., and von Samson-Himmelstjerna, G. (2010) Veterinary Parasitology Adaptation and evaluation of three different in vitro tests for the detection of resistance to anthelmintics in gastro intestinal nematodes of cattle. Vet. Parasitol. 170, 61-70.
(61) Bartley, D. J., Jackson, E., Johnston, K., Coop, R. L., Mitchell, G. B. B., Sales, J., and Jackson, F. (2003) A survey of anthelmintic resistant nematode parasites in Scottish sheep flocks. Vet. Parasitol. 117, 61-71.
(62) Sherman, F. (2002) Getting Started with Yeast. Methods Enzymol. 350, 3-41.
(63) Tiefenbach, J., Magomedova, L., Liu, J., Reunov, A. A., Tsai, R., Eappen, N. S., Jockusch, R. A., Nislow, C., Cummins, C. L., and Krause, H. M. (2018) Idebenone and coenzyme Q10 are novel PPARa/y ligands, with potential for treatment of fatty liver diseases. Dis. Model. Mech. 11, 1-10.
(64) Jindapunnapat, K., Reetz, N. D., Macdonald, M. H., Bhagavathy, G., and Meyer, S. L. F. (2018) Activity of Vetiver Extracts and Essential Oil against Meloidogyne incognita. J. Nematol. 50, 147-162.
(65) Meyer, S. L. F., Chauhan, K. R., and MacDonald, M. H. (2016) EVALUATION OF ROSELLE (HIBISCUS SABDARIFFA) LEAF AND POMEGRANATE (PUNICA GRANATUM) FRUIT RIND FOR ACTIVITY AGAINST MELOIDOGYNE INCOGNITA. Nematropica 46, 85-96.
(66) Meyer, S. L. F., Zasada, I. A., Roberts, D. P., Vinyard, B. T., Lakshman, D. K., Lee, J.-K., Chitwood, D. J., and Carta, L. K. (2006) Plantago lanceolata and Plantago rugelii Extracts are Toxic to Meloidogyne incognita but not to Certain Microbes. J. Nematol. 38, 333-338.
(67) McLeod and Khair. Annals of Applied Biology. 79, 329-341 (1975).
(68) Krishna-Prasad and Rao. Indian Journal of Nematology. 10(2), 216-224 (1980).
(69) Whitehead et al. Annals of Applied Biology. 106, 489-498 (1985).
(70) Hu et al. PLOS One. 8(7):e70702 (2013).
(71) Thienpont et al. Nature 209, 1084-1086.
(72) Redman, E. et al. Microsatellite analysis reveals marked genetic differentiation between Haemonchus contortus laboratory isolates and provides a rapid system of genetic fingerprinting. Int. J. Parasitol. 38, 111-122 (2008).
(73) Wram, C. L. and Zasada, I. A. (2019) Short-Term Effects of Sublethal doses of Nematicides on Meloidogyne incognita. Phytopathology. 109(9), 1605-1613.
(74) Akhtar, M. and Malik, A. (2000) Roles of organic soil amendments and soil organisms in the biological control of plant-parasitic nematodes: a review. Bioresource Technology. 74(1), 35-47.
(75) Lacey L. A. and Georgis R. (2012) Entomopathogenic Nematodes for Control of Insect Pests Above and Below Ground with Comments on Commercial Production. Journal of Nematology. 44(2), 218-225.
(76) Chundawat, T. S.; Kumari, P.; Sharma, N.; Bhagat, S. Strategic Synthesis and in Vitro Antimicrobial Evaluation of Novel Difluoromethylated 1-(1, 3-Diphenyl-1H-Pyrazol-4-YI)-3, 3-Difluoro-1, 3-Dihydro-Indol-2-Ones. Med. Chem. Res. 2016, 25 (10), 2335-2348.
(77) Pyl, T.; Giebelmann, R.; Beyer, H. Uber Bicyclische Heterocyclen Mit Gemeinsamem Stickstoffatom, I. Zur Kenntnis Der Imidazo[2,1-b]Thiazole. Justus Liebigs Ann. Chem. 1961, 643 (1), 145-153.
(78) Sukhonosova, E. V.; Statsyuk, V. E.; Ostapenko, G. I.; Bunev, A. S. Cyclization of 2-Amino-4-Methyl-3-[2-Aryl(Hetaryl)-2-Oxoethyl]-Thiazolium Bromides in Aqueous Medium. A Simple Synthesis of Substituted Imidazo[2,1-b]Thiazoles. Russ. J. Org. Chem. 2014, 50 (12), 1856-1859.

1. A method of treating or preventing a nematode infection in a plant or for treating or preventing a disease, disorder or condition in a plant arising from a nematode infection comprising administering to a plant in need thereof, an effective amount of one or more compounds of Formula (I) 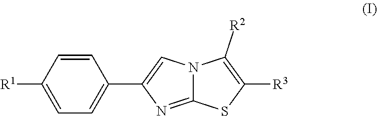
and/or solvates thereof,
wherein:
R¹ is selected from H and halo; and
R² and R³ are independently selected from H and C₁₋₄alkyl.

2. (canceled)

3. The method of claim 1, wherein R¹ is selected from Cl, F and Br.

4. (canceled)

5. The method of claim 1, wherein R¹ is H.

6. The method of claim 1, wherein R² and R³ in the compounds of Formula (I) are independently selected from H, CH₃, CH₃, CH₂CH₃, CH(CH₃)₂ and C(CH₃)₃.

7. (canceled)

8. The method of claim 1, wherein one of R² and R³ is H and the other is CH₃.

9. The method of claim 1, wherein R² and R³ are both H.

10. The method of claim 1, wherein the compound of Formula (I) is selected from one or more of: 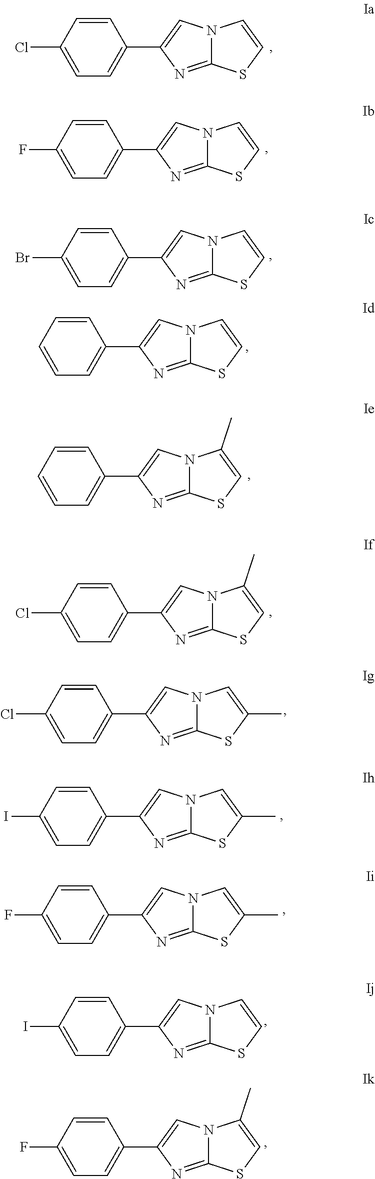 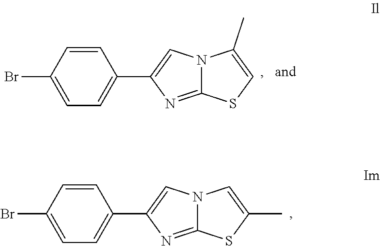 [SMILES: Cc1csc2nc(-c3ccc(Br)cc3)cn12 ; Cc1cn2cc(-c3ccc(Br)cc3)nc2s1]
and/or solvates thereof.

11. The method of claim 10, wherein the compound of Formula (I) is selected from one or more of: 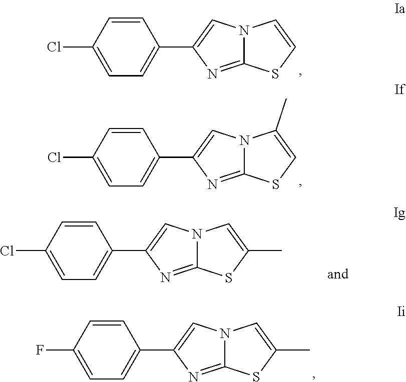
and/or solvates thereof.

12. The method of claim 11, wherein the compound of Formula (I) is 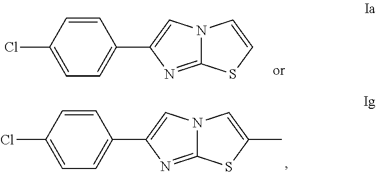
and/or solvates thereof.

13. The method of claim 1, wherein the nematode infection is an infection of an endoparasitic nematode or an ectoparasitic nematode.

14. The method of claim 1, wherein the nematode infection is an infection of a nematode selected from one or more of the following genera: Meloidogyne, Heterodera, Globodera, Pratylenchus, Rotylenchulus, Hoplolaimus, Bolonolaimus, Longidorus, Paratrichodorus, Ditylenchus, Bursaphalencus, Xiphinema, Nacobbus, Aphelenchoides, Helicotylenchus, Radopholus, Hirschmanniella, Tylenchorhynchus, Trichodorus, Anguina, Criconema, Criconemella, Criconemoides, Mesocriconema, Dolichodorus, Hemicycliophora, Hemicriconemoides, Scutellonema, Tylenchulus, Subanguina, Hypsoperine, Macroposthonia, Melinius, Punctodera, and Quinisulcius.

15. The method of claim 14, wherein the nematode infection is an infection of a nematode of the genus Meloidogyne.

16. (canceled)

17. (canceled)

18. The method of claim 1, wherein the plant is selected from one or more of soybeans, cotton, flax, hemp, jute, corn, tobacco, nuts, almonds, coffee, tea, pepper, grapevines, hops, wheat, barley, rye, oats, rice, maize, sorghum, apples, pears, plums, peaches, banana, plantains, cherries, strawberries, raspberries, blackberries, beans, lentils, peas, soya, oilseed rape, mustard, poppies, olives, sunflowers, coconut, castor, cocoa, ground nuts, spinach, asparagus, lettuce, cabbages, carrots, onions, tomatoes, potatoes, bell peppers, cucumbers, melons, pumpkins, sugar cane, sugar beet, fodder beet, avocado, cinnamonium, camphor, oranges, tangerines, lemons, limes, grapefruit, latex plants, ornamental plants and turf grasses.

19. The method of claim 1, wherein the disease, disorder or condition arising from a nematode infection is selected from stunted growth, bulb discoloration, swollen stems, root knots, root galls, root cysts, root lesions, root necrosis, toppling disease, blackhead disease, and pine wilt.

20. The method of claim 1, wherein the method comprises applying to the plant, to the soil surrounding the plant, and/or to the seeds of the plant an effective amount of one or more compounds of Formula (I) and/or solvates thereof.

21. The method of claim 1, wherein the one or more compounds of Formula (I) and/or solvates thereof is used in combination with other known agents useful for treating or preventing a nematode infection

22. The method of claim 1, wherein the one or more compounds of Formula (I) and/or solvates thereof is used in combination with other known agents useful for treating or preventing a disease, disorder or condition arising from a nematode infection in a plant.

23. A composition for treating or preventing a nematode infection or a disease, a disorder, or a condition arising from a nematode infection in a plant comprising an effective amount of one or more compounds of Formula (I) 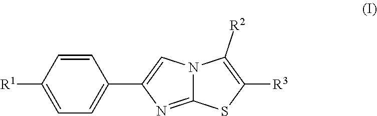
and/or solvates thereof,
wherein:
R¹ is selected from H and halo; and
R² and R³ are independently selected from H and C₁₋₄alkyl, and one or more carriers.

24. The composition of claim 23, wherein the one or more carriers is one or more agricultural excipients or one or more solvents or combinations thereof.

25. The composition of claim 23, wherein composition is a ready to use composition and the amount of the one or more compounds of Formula (I) and/or solvates thereof in the composition is about 0.001 μM to about 100 mM about 0.01 μM to about 10 mM, 0.1 μM to about 500 μM, about 1.0 μM to about 250 μM, or about 5.0 μM to about 100 μM.
